(19) United States
(12) Patent Application Publication
(10) Pub. No.: US 2008/0062167 A1
(43) Pub. Date: Mar. 13, 2008

(54) Computer-based system and method for providing situational awareness for a structure using three-dimensional modeling

(75) Inventors: Joseph A. Boggs, Annapolis, MD (US); Michael C. Pachler, Annapolis, MD (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: International Design and Construction Online, Inc., Annapolis, MD (US)

(21) Appl. No.: 11/519,934

(22) Filed: Sep. 13, 2006

(51) Int. Cl. G06T 15/00

(52) U.S. Cl. 345/419

(57) ABSTRACT

A system for providing real-time or near real-time situational awareness for a structure includes a database module for storing structural information associated with the structure. The system includes a situational awareness module for gathering situational awareness information associated with the structure. The system includes a three-dimensional (3-D) rendering module in communication with the database module and the situational awareness module for rendering a 3-D virtual model of the structure utilizing the structural information associated with the structure, and for integrating into the 3-D virtual model the situational awareness information associated with the structure. The system includes a graphical user interface module in communication with the 3-D rendering module for displaying to a user the 3-D virtual model of the structure integrating the situational awareness information associated with the structure.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever.

### BACKGROUND

1. Field of the Invention

The present invention relates to information systems. More particularly, the present invention relates to a computer-based system and method for providing real-time or near real-time situational awareness for a structure using three-dimensional modeling.

2. Background Information

Situational awareness is the perception of the elements in an environment, the comprehension of the meaning and relative importance of those elements, and the projection of the status of those elements into the near future. In other words, situational awareness involves an individual's state of knowledge or mental model of a situation occurring around that person, in which a constantly-evolving picture of the state of the environment is presented to the individual. Situational awareness is important for effective decision making and performance in any complex and dynamic environment.

Particularly in the wake of the tragic events of Sep. 11, 2001, it has become critical that the infrastructure of the United States be protected and that the nation's “first responders” and emergency personnel be equipped with the vital information they need to adequately respond to accidents, natural disasters, terrorist attacks and other emergency situations. Currently, a problem exists in that vital information about buildings, facilities, and internal utilities is not readily accessible in the event of an emergency. When seconds count, the information must be readily available and accessible in the field. However, such critical information is either kept in paper drawings that are locked away in storage, or in computer-aided design (CAD) drawings that are equally difficult to locate quickly. Locating such information quickly is particularly difficult in cases where the documents or electronic data are at the location where the network system or storage facilities have been disrupted. Furthermore, paper drawings and individual CAD files can lack critical information on how a building or facility is interrelated with other buildings, facilities, and utilities in the immediate surrounding area. Thus, during an emergency, not only is critical information about the local site missing, but also the effect of the emergency at the local site on the overall wide-area infrastructure.

The 2001 terrorist attacks in New York and Virginia, the 2003 blackout across Northeastern America, and the devastating Hurricane Katrina of 2005 painfully illustrate how such vulnerabilities in accessing critical information can slow relief efforts and fail to prevent cascading faults. The ability to quickly understand the situation and vulnerabilities at the site, as well as the local, regional, and national vulnerabilities that exist during a crisis, and the ability to act immediately with an optimal response can save lives and minimize costs by accelerating recovery time and minimizing property damage.

Therefore, there is a need for a system that can provide first responders and other emergency personnel with “drill-down” capabilities into the interior of building structures that can be used for responding to emergencies and other like situations where such critical information is required for situation assessment and response planning.

### SUMMARY OF THE INVENTION

A computer-based system and method for providing situational awareness for a structure using three-dimensional modeling are disclosed. In accordance with exemplary embodiments of the present invention, according to a first aspect of the present invention, a system for providing situational awareness for a structure includes a database module. The database module is configured to store structural information associated with the structure. The system includes a situational awareness module. The situational awareness module is configured to gather situational awareness information associated with the structure. The system includes a three-dimensional (3-D) rendering module in communication with the database module and the situational awareness module. The 3-D rendering module is configured to render a 3-D virtual model of the structure utilizing the structural information associated with the structure. The 3-D rendering module is configured to integrate into the 3-D virtual model the situational awareness information associated with the structure. The system includes a graphical user interface (GUI) module in communication with the 3-D rendering module. The GUI module is configured to display to a user the 3-D virtual model of the structure integrating the situational awareness information associated with the structure.

According to the first aspect, the system can include a path selection module in communication with the 3-D rendering module. The path selection module can be configured to determine ingress and/or egress routes through the structure using the structural information and situational awareness information associated with the structure. The 3-D rendering module can be configured to render in the 3-D virtual model the ingress and/or egress routes for display to the user. For example, the egress routes through the structure can comprise evacuation routes from the structure. The path selection module can be configured to determine the shortest route between points within the structure, and the 3-D rendering module can be configured to render in the 3-D virtual model the shortest route for display to the user. The path selection module can be configured to maintain a list of substantially all individual paths through the structure. Each of the individual paths through the structure can be assigned a path weight in accordance with the length of the individual path and/or the level of difficulty in traversing the individual path. A route between points in the structure can comprise one or more individual paths. The path selection module can be configured to generate the total path weight of the route by summing the path weights of the individual paths that comprise the route. The 3-D rendering module can be configured to render in the 3-D virtual model the route between the points in the structure with the lowest total path weight for display to the user. The path selection module can be configured to receive modifications of path weights to alter the route between the points in the structure. The path selection module can be configured to calculate distance measurements for each of the ingress and egress routes through the structure for display to the user.

According to the first aspect, the system can include a communication module in communication with the situational awareness module. The communication module can be configured to transmit and receive the situational awareness information. For example, the communication module can be configured to transmit and receive the situational awareness information for collaborative situation assessment and response planning. For example, the communication module can be configured to communicate situational awareness information with crisis incident management systems, integrated incident management systems and the like. The system can include a model translation module in communication with the 3-D rendering module and the GUI module. The model translation module can be configured to convert the 3-D virtual model rendered by the 3-D rendering module into a format displayable by the GUI module. For example, the GUI module can be configured to display the 3-D virtual model of the structure integrating the situational awareness information associated with the structure on a portable display device. For example, the GUI module can be configured to display the 3-D virtual model of the structure integrating the situational awareness information associated with the structure through a Web browser.

According to the first aspect, the system can include a simulation module in communication with the 3-D rendering module. The simulation module can be configured to generate simulations of situational awareness scenarios associated with the structure. The system can include a situational awareness response module in communication with the 3-D rendering module. The situational awareness response module can be configured to generate at least one proposed response to an emergency or other critical situation occurring within the structure. The structural information used by the 3-D rendering module to render the 3-D virtual model can include attributes of objects associated with the structure. The GUI module can be configured to display the attributes of each object to the user upon request. For example, the GUI module can be configured to display callouts for presenting the attributes of each object within the structure to the user. The 3-D virtual model can comprise a parametric 3-D virtual model. Accordingly, a modification to at least one attribute of a first object can be configured to cause the 3-D rendering module to modify attributes of at least a second object associated with the first object within the parametric 3-D virtual model. Alternatively or additionally, the objects can comprise smart objects. Accordingly, the 3-D rendering module can be configured to render an impact of an action directed to a smart object using the attributes of the smart object and a nature of the action for display to the user.

According to the first aspect, the situational awareness information can include sensor data received from sensors associated with the structure. For example, the sensors can include smoke sensors, infrared or flame sensors, video surveillance cameras or closed-circuit television, audio sensors, motion sensors and the like. The sensor data can comprise historical sensor data and real-time or substantially real-time sensor data. The 3-D rendering module can be configured to render in the 3-D virtual model the sensor data for display to the user. One or more sensors can be displayed within the 3-D virtual model as linking points. Accordingly, a user selection of a linking point can be configured to display to the user the sensor data received from the corresponding sensor. The situational awareness information can include information associated with an emergency occurring within the structure. The situational awareness information can include alert or alarm notifications associated with the structure. The situational awareness information can include environmental information associated with the structure. Accordingly, the 3-D rendering module can be configured to render in the 3-D virtual model the environmental information for displaying to the user an environment in which the structure resides.

According to the first aspect, the 3-D rendering module can be configured to render in the 3-D virtual model locations of objects within the structure for display to the user. For example, the objects can include people. The GUI module can be configured to display layers of the 3-D virtual model to the user for viewing structural elements and/or internal layouts of the structure. For example, the structural elements can include plumbing systems, electrical systems, mechanical systems, environmental systems, emergency equipment systems of the structure and the like. The GUI module can be configured to receive instructions from the user for navigating the 3-D virtual model to examine the structure and the situational awareness information associated with the structure. The database module can be configured to store at least one of the situational awareness information associated with the structure and the 3-D virtual model of the structure integrating the situational awareness information. The GUI module can comprise a geographic information system (GIS) or the like. The 3-D virtual model can comprise a photo-realistic representation of the structure. The 3-D virtual model of the structure integrating the situational awareness information associated with the structure can displayed to the user over a network, such as an intranet or internet (e.g., the Internet or World Wide Web). The structure can comprise a building or any other suitable type of facility.

According to a second aspect of the present invention, an emergency response system includes a situational awareness engine. The situational awareness engine is configured to gather situational awareness information associated with a facility. The system includes a 3-D model generation engine in communication with the situational awareness engine. The 3-D virtual model generation engine is configured to generate a 3-D virtual model of the facility utilizing structural information associated with the facility. The 3-D virtual model generation engine is configured to incorporate into the 3-D virtual model the situational awareness information associated with the facility. The system includes a display engine in communication with the 3-D virtual model generation engine. The display engine is configured to display the 3-D virtual model of the facility incorporate the situational awareness information associated with the facility to a user for navigating the 3-D virtual model for situation assessment and emergency response planning.

According to the second aspect, the situational awareness engine can comprise a storage device. The storage device can be configured to store at least one of the structural information associated with the facility, the situational awareness information associated with the facility, and the 3-D virtual model of the facility generated by the 3-D virtual model generation engine. The situational awareness engine can comprise a transceiver. The transceiver can be configured to transmit and receive the situational awareness information. the system can include a situational awareness response engine in communication with the 3-D virtual model generation engine. The situational awareness response engine can be configured to generate at least one proposed response to an emergency situation occurring within the facility. The situational awareness response engine can comprise a simulation engine. The simulation engine can be configured to generate simulations of situational awareness scenarios associated with the facility. The situational awareness response engine can comprise a path determination engine. The path determination engine can be configured to determine ingress and/or egress routes through the facility using the structural information and situational awareness information associated with the facility. The 3-D virtual model generation engine can be configured to render in the 3-D virtual model the at least one of ingress and egress routes for display to the user. The path determination engine can be configured to maintain a list of substantially all individual paths through the facility. A route between points in the facility can comprise at least one individual path. Each of the individual paths through the facility can be assigned a path weight in accordance with the length of the individual path and/or the level of difficulty in traversing the individual path. The path determination engine can be configured to generate the total path weight of the route by summing the path weights of the individual paths that comprise the route. The 3-D virtual model generation engine can be configured to generate in the 3-D virtual model the route between the points in the facility with a lowest total path weight for display to the user. The 3-D virtual model generation engine can comprise a model translation engine. The model translation engine can be configured to convert the 3-D virtual model generated by the 3-D virtual model generation engine into a format displayable by the display engine.

According to a third aspect of the present invention, a method of providing situational awareness for a structure includes the steps of: a.) collecting structural information associated with the structure; b.) gathering situational awareness information associated with the structure; c.) rendering a 3-D virtual model of the structure utilizing the structural information associated with the structure; d.) integrating into the 3-D virtual model the situational awareness information associated with the structure; and e.) displaying to a user the 3-D virtual model of the structure integrating the situational awareness information associated with the structure.

According to the third aspect, the method can include the steps of: f.) determining ingress and/or egress routes through the structure using the structural information and situational awareness information associated with the structure; and g.) rendering in the 3-D virtual model the ingress and/or egress routes for display to the user. For example, the egress routes through the structure can include evacuation routes from the structure. Step (f) can include the step of: f1.) determining a shortest route between points within the structure. Accordingly, step (g) can include the step of: g1.) rendering in the 3-D virtual model the shortest route for display to the user. Additionally or alternatively, step (f) can include the steps of: f1.) maintaining a list of substantially all individual paths through the structure; f2.) assigning a path weight to each of the individual paths through the structure in accordance with at least one of a length of the individual path and a level of difficulty in traversing the individual path, wherein a route between points in the structure can comprise at least one individual path; and f3.) summing the path weights of the individual paths that comprise the route to generate a total path weight of the route. Accordingly, step (g) can include the step of: g1.) rendering in the 3-D virtual model the route between the points in the structure with a lowest total path weight for display to the user. Step (f) can further include the step of: f4.) modifying path weights to alter the route between the points in the structure. Additionally or alternatively, step (f) can include the step of: f1.) calculating distance measurements for each of the ingress and egress routes through the structure for display to the user.

According to the third aspect, the method can include the step of: h.) transmitting and receiving the situational awareness information. Step (h) can include the step of: h1.) communicating the situational awareness information for collaborative situation assessment and response planning. Additionally or alternatively, step (h) can include the step of: h1.) communicating the situational awareness information with crisis incident management systems, integrated incident management systems, and the like. The method can include the step of: i.) converting the 3-D virtual model into a format displayable in step (e). Step (e) can include the step of: e1.) displaying the 3-D virtual model of the structure integrating the situational awareness information associated with the structure on a portable display device. Additionally or alternatively, step (e) can include the step of: e1.) displaying the 3-D virtual model of the structure integrating the situational awareness information associated with the structure through a Web browser. The method can include the steps of: j.) generating simulations of situational awareness scenarios associated with the structure; and/or k.) generating at least one proposed response to an emergency situation occurring within the structure. The structural information used in step (c) to render the 3-D virtual model can include attributes of objects associated with the structure. Step (e) can include the step of: e1.) displaying the attributes of each object to the user upon request. For example, step (e) can include the step of: e2.) displaying callouts for presenting the attributes of each object within the structure to the user.

According to the third aspect, the 3-D virtual model can comprise a parametric 3-D virtual model. Accordingly, step (c) can include the steps of: c1.) receiving a modification to at least one attribute of a first object; and c2.) modifying attributes of at least a second object associated with the first object within the parametric 3-D virtual model. Additionally or alternatively, the objects can comprise smart objects. Accordingly, step (c) can include the step of: c1.) rendering an impact of an action directed to a smart object using the attributes of the smart object and a nature of the action for display to the user. The situational awareness information can include sensor data received from sensors associated with the structure. For example, the sensors can include smoke sensors, infrared sensors, video surveillance cameras, motion sensors and the like. The sensor data can comprise historical sensor data and real-time or substantially real-time sensor data. Step (d) can comprise the step of: d1.) rendering in the 3-D virtual model the sensor data for display to the user. Step (e) can comprise the steps of: e1.) displaying at least one sensor within the 3-D virtual model as a linking point; and e2.) displaying to the user the sensor data received from the sensor upon user selection of a corresponding linking point.

According to the third aspect, the situational awareness information can include information associated with an emergency occurring within the structure. The situational awareness information can include alert notifications associated with the structure. The situational awareness information can include environmental information associated with the structure. Accordingly, step (d) can include the step of: d1.) rendering in the 3-D virtual model the environmental information for displaying to the user an environment in which the structure resides. Additionally or alternatively, step (d) can include the step of: d2.) rendering in the 3-D virtual model locations of objects within the structure for display to the user. The objects can include people. Step (e) can include the step of: e1.) displaying layers of the 3-D virtual model to the user for viewing at least one of structural elements and internal layouts of the structure. For example, the structural elements can include one or more of plumbing systems, electrical systems, mechanical systems, environmental systems, emergency equipment systems of the structure and the like. Step (e) can include the step of: e2.) receiving instructions from the user for navigating the 3-D virtual model to examine the structure and the situational awareness information associated with the structure. The method can include the step of: 1.) storing at least one of situational awareness information associated with the structure and the 3-D virtual model of the structure integrating the situational awareness information. Step (e) can include the step of: e3.) displaying the 3-D virtual model of the structure integrating the situational awareness information associated with the structure using a GIS. The 3-D virtual model can comprise a photo-realistic representation of the structure or the like. Step (e) can include the step of: e4.) displaying the 3-D virtual model of the structure integrating the situational awareness information associated with the structure to the user over a network. The network can comprise an internet or an intranet. The structure can comprise a building or other suitable type of facility.

According to a fourth aspect of the present invention, a method of responding to an emergency, includes the steps of: a.) generating a 3-D virtual model of a facility utilizing structural information associated with the facility; b.) gathering situational awareness information associated with the facility; c.) rendering into the 3-D virtual model the situational awareness information associated with the facility; and d.) displaying the 3-D virtual model of the facility integrating the situational awareness information associated with the facility to a user for navigating the 3-D virtual model for situation assessment and emergency response planning.

According to the fourth aspect, step (b) can include the step of: b1.) storing the structural information associated with the facility, the situational awareness information associated with the facility, and/or the 3-D virtual model of the facility generated by the 3-D virtual model generation engine. Step (b) can include the step of: b2.) communicating the situational awareness information. The method can include the step of: e.) generating at least one proposed response to an emergency situation occurring within the facility. Step (e) can include the step of: e1.) generating simulations of situational awareness scenarios associated with the facility. Additionally or alternatively, step (e) can include the step of: e2.) determining ingress and/or egress routes through the facility using the structural information and situational awareness information associated with the facility. Accordingly, step (c) can include the step of: c1.) rendering in the 3-D virtual model the ingress and/or egress routes for display to the user. Step (e2) can include the steps of: e3.) maintaining a list of substantially all individual paths through the facility, wherein a route between points in the facility can comprise at least one individual path; e4.) assigning a path weight to each of the individual paths through the facility in accordance with the length of the individual path and/or the level of difficulty in traversing the individual path; e5.) generating a total path weight of the route by summing the path weights of the individual paths that comprise the route; and wherein step (c) can include the step of: c2.) rendering in the 3-D virtual model the route between the points in the facility with a lowest total path weight for display to the user. The method can include the step of: f.) converting the 3-D virtual model into a format displayable in step (d).

According to a fifth aspect of the present invention, a system for providing situational awareness for a structure includes means for storing structural information associated with the structure. The system includes means for gathering situational awareness information associated with the structure. The system includes means for rendering a 3-D virtual model of the structure utilizing the structural information associated with the structure. The rendering means is configured to integrate into the 3-D virtual model the situational awareness information associated with the structure. The rendering means is in communication with the storing means and the gathering means. The system includes means for displaying to a user the 3-D virtual model of the structure integrating the situational awareness information associated with the structure. The displaying means is in communication with the rendering means.

According to the fifth aspect, the system can include means for selecting a path in communication with the rendering means. The path selecting means can be configured to determine ingress and/or egress routes through the structure using the structural information and situational awareness information associated with the structure. The rendering means can be configured to render in the 3-D virtual model the ingress and/or egress routes for display to the user. For example, the egress routes through the structure can include evacuation routes from the structure. The path selecting means can be configured to determine the shortest route between points within the structure. The rendering means can be configured to render in the 3-D virtual model the shortest route for display to the user. The path selecting means can be configured to maintain a list of substantially all individual paths through the structure. Each of the individual paths through the structure can be assigned a path weight in accordance with the length of the individual path and/or the level of difficulty in traversing the individual path. A route between points in the structure can comprise at least one individual path. The path selecting means can be configured to generate the total path weight of the route by summing the path weights of the individual paths that comprise the route. Accordingly, the rendering means can be configured to render in the 3-D virtual model the route between the points in the structure with the lowest total path weight for display to the user. Additionally or alternatively, the path selecting means can be configured to receive modifications of path weights to alter the route between the points in the structure. The path selecting means can also be configured to calculate distance measurements for each of the ingress and egress routes through the structure for display to the user.

According to the fifth aspect, the system can include means for communicating in communication with the gathering means. The communicating means can be configured to transmit and receive the situational awareness information. The communicating means can be configured to transmit and receive the situational awareness information for collaborative situation assessment and response planning. For example, the communicating means can be configured to communicate situational awareness information with crisis incident management systems, integrated incident management systems and the like. The system can include means for converting in communication with the rendering means and the displaying means. The converting means can be configured to convert the 3-D virtual model rendered by the rendering means into a format displayable by the displaying means. The displaying means can be configured to display the 3-D virtual model of the structure integrating the situational awareness information associated with the structure on a portable display device. Additionally or alternatively, the displaying means can be configured to display the 3-D virtual model of the structure integrating the situational awareness information associated with the structure through a Web browser. The system can include means for simulating in communication with the rendering means. The simulating means can be configured to generate simulations of situational awareness scenarios associated with the structure. The system can include means for generating situational awareness responses in communication with the rendering means. The situational awareness response generating means can be configured to generate one or more proposed responses to an emergency or other critical situation occurring within the structure.

According to the fifth aspect, the structural information used by the rendering means to render the 3-D virtual model can include attributes of objects associated with the structure. The displaying means can be configured to display the attributes of each object to the user upon request. The displaying means can be configured to display callouts for presenting the attributes of each object within the structure to the user. The 3-D virtual model can comprise a parametric 3-D virtual model. Accordingly, a modification to at least one attribute of a first object can be configured to cause the rendering means to modify attributes of at least a second object associated with the first object within the parametric 3-D virtual model. Additionally or alternatively, the objects can comprise smart objects. Accordingly, the rendering means can be configured to render an impact of an action directed to a smart object using the attributes of the smart object and a nature of the action for display to the user.

According to the fifth aspect, the situational awareness information can include sensor data received from sensors associated with the structure. The sensors can include smoke sensors, infrared sensors, video surveillance cameras, motion sensors and the like. The sensor data can comprise historical sensor data and real-time or near real-time sensor data. The rendering means can be configured to render in the 3-D virtual model the sensor data for display to the user. For example, at least one sensor can be displayed within the 3-D virtual model as a linking point. A user selection of a linking point can be configured to display to the user the sensor data received from the corresponding sensor. The situational awareness information can include information associated with an emergency occurring within the structure. The situational awareness information can include alert or alarm notifications associated with the structure. The situational awareness information can include environmental information associated with the structure. Accordingly, the rendering means can be configured to render in the 3-D virtual model the environmental information for displaying to the user an environment in which the structure resides. The rendering means can be configured to render in the 3-D virtual model locations of objects within the structure for display to the user. The objects can include, for example, people.

According to the fifth aspect, the displaying means can be configured to display layers of the 3-D virtual model to the user for viewing structural elements and/or internal layouts of the structure. The structural elements can include one or more of plumbing systems, electrical systems, mechanical systems, environmental systems, emergency equipment systems of the structure and the like. The displaying means can be configured to receive instructions from the user for navigating the 3-D virtual model to examine the structure and the situational awareness information associated with the structure. The storing means can be configured to store at least one of the situational awareness information associated with the structure and the 3-D virtual model of the structure integrating the situational awareness information. The displaying means can comprise a geographic information means or the like. The 3-D virtual model can comprise a photo-realistic representation of the structure. The 3-D virtual model of the structure integrating the situational awareness information associated with the structure can be displayed to the user over a network. For example, the network can comprise any suitable form of internet or intranet. The structure can comprise a building or any other suitable type of facility.

According to a sixth aspect of the present invention, an emergency response system includes means for collecting situational awareness information associated with a facility. The system includes means for generating a 3-D virtual model of the facility utilizing structural information associated with the facility. The 3-D virtual model generating means is configured to incorporate into the 3-D virtual model the situational awareness information associated with the facility. The 3-D virtual model generating means is in communication with the collecting means. The system includes means for displaying the 3-D virtual model of the facility incorporate the situational awareness information associated with the facility to a user for navigating the 3-D virtual model for situation assessment and emergency response planning. The displaying means is in communication with the 3-D virtual model generating means. The collecting means can comprise means for storing one or more of the structural information associated with the facility, the situational awareness information associated with the facility, and the 3-D virtual model of the facility generated by the 3-D virtual model generating means. The collecting means can comprise means for transceiving. The transceiving means can be configured to transmit and receive the situational awareness information.

According to the sixth aspect, the system can include means for generating situational awareness responses in communication with the 3-D virtual model generating means. The situational awareness response generating means can be configured to generate at least one proposed response to an emergency situation occurring within the facility. The situational awareness response generating means can comprise means for generating simulations of situational awareness scenarios associated with the facility. The situational awareness response generating means can comprise means for determining paths. The path determining means can be configured to determine ingress and/or egress routes through the facility using the structural information and situational awareness information associated with the facility. Accordingly, the 3-D virtual model generating means is configured to render in the 3-D virtual model the ingress and/or egress routes for display to the user. Additionally or alternatively, the path determining means can be configured to maintain a list of substantially all individual paths through the facility. A route between points in the facility can comprise at least one individual path. Each of the individual paths through the facility can be assigned a path weight in accordance with the length of the individual path and/or the level of difficulty in traversing the individual path. The path determining means can be configured to generate the total path weight of the route by summing the path weights of the individual paths that comprise the route. Accordingly, the 3-D virtual model generating means can be configured to generate in the 3-D virtual model the route between the points in the facility with the lowest total path weight for display to the user. The 3-D virtual model generating means can comprise means for converting the 3-D virtual model generated by the 3-D virtual model generating means into a format displayable by the displaying means.

According to a seventh aspect of the present invention, a computer-readable medium contains a computer program for providing situational awareness for a structure. The computer program performs the steps of: a.) receiving structural information associated with the structure; b.) receiving situational awareness information associated with the structure; c.) rendering a 3-D virtual model of the structure utilizing the structural information associated with the structure; d.) integrating into the 3-D virtual model the situational awareness information associated with the structure; and e.) generating display information for displaying to a user the 3-D virtual model of the structure integrating the situational awareness information associated with the structure.

According to the seventh aspect, the computer program can perform the steps of: f.) determining at least one of ingress and egress routes through the structure using the structural information and situational awareness information associated with the structure; and g.) rendering in the 3-D virtual model the at least one of ingress and egress routes for display to the user. For step (f) the computer program can perform the step of: f1.) determining a shortest route between points within the structure; and for step (g) the computer program can perform the step of: g1.) rendering in the 3-D virtual model the shortest route for display to the user. Additionally or alternatively, for step (f) the computer program can perform the steps of: f1.) storing a list of substantially all individual paths through the structure; f2.) assigning a path weight to each of the individual paths through the structure in accordance with at least one of a length of the individual path and a level of difficulty in traversing the individual path, wherein a route between points in the structure can comprise at least one individual path; and f3.) summing the path weights of the individual paths that comprise the route to generate a total path weight of the route; and wherein for step (g) the computer program performs the step of: g1.) rendering in the 3-D virtual model the route between the points in the structure with a lowest total path weight for display to the user.

According to the seventh aspect, for step (f) the computer program can further perform the step of: f4.) modifying path weights to alter the route between the points in the structure. Additionally or alternatively, for step (f) the computer program can perform the step of: f1.) calculating distance measurements for each of the ingress and egress routes through the structure for display to the user. The computer program performs the steps of: h.) converting the 3-D virtual model into a format displayable in step (e); i.) generating simulations of situational awareness scenarios associated with the structure; and/or j.) generating at least one proposed response to an emergency situation occurring within the structure. For step (e) the computer program can perform the step of: e1.) receiving instructions from the user for navigating the 3-D virtual model to examine the structure and the situational awareness information associated with the structure. The computer program can perform the step of: k.) storing at least one of situational awareness information associated with the structure and the 3-D virtual model of the structure integrating the situational awareness information.

According to an eighth aspect of the present invention, a computer-readable medium contains a computer program for responding to an emergency or other critical situation. The computer program performs the steps of: a.) generating a 3-D virtual model of a facility utilizing structural information associated with the facility; b.) receiving situational awareness information associated with the facility; c.) rendering into the 3-D virtual model the situational awareness information associated with the facility; and d.) generating display information for displaying the 3-D virtual model of the facility integrating the situational awareness information associated with the facility to a user for navigating the 3-D virtual model for situation assessment and emergency response planning.

According to the eighth aspect, the computer program can perform the step of: e.) generating at least one proposed response to an emergency situation occurring within the facility. For step (e) the computer program can perform the step of: e1.) generating simulations of situational awareness scenarios associated with the facility. Additionally or alternatively, for step (e) the computer program can perform the steps of: e2.) determining at least one of ingress and egress routes through the facility using the structural information and situational awareness information associated with the facility. Accordingly, for step (c) the computer program can perform the step of: c1.) rendering in the 3-D virtual model the at least one of ingress and egress routes for display to the user. For step (e1), the computer program can perform the steps of: e3.) storing a list of substantially all individual paths through the facility, wherein a route between points in the facility can comprise at least one individual path; e4.) assigning a path weight to each of the individual paths through the facility in accordance with at least one of a length of the individual path and a level of difficulty in traversing the individual path; e5.) generating a total path weight of the route by summing the path weights of the individual paths that comprise the route. Accordingly, for step (c) the computer program can perform the step of: c2.) rendering in the 3-D virtual model the route between the points in the facility with a lowest total path weight for display to the user.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a block diagram illustrating a system for providing situational awareness for a structure, in accordance with an exemplary embodiment of the present invention.

FIG. 2 is a flowchart illustrating steps for collecting structural information associated with a structure for use in rendering the 3-D virtual model of the structure using the REVIT™ Building software application, in accordance with an exemplary embodiment of the present invention.

FIG. 3 is a diagram illustrating the various types of information that can comprise the 3-D virtual model, in accordance with an exemplary embodiment of the present invention.

FIG. 4 is a block diagram illustrating an emergency response system, in accordance with an alternative exemplary embodiment of the present invention.

FIG. 5 is a schematic illustrating an application layer diagram for the Emergency Response System, in accordance with an exemplary embodiment of the present invention.

FIG. 6 is a schematic illustrating an example of a hardware/software architecture of the Emergency Response System, in accordance with an exemplary embodiment of the present invention.

FIG. 7 is first diagram illustrating a 3-D virtual model of a structure that was created with REVIT™ Building and being displayed in GOOGLE™ Earth, in accordance with an exemplary embodiment of the present invention.

FIG. 8 is a second diagram illustrating the 3-D virtual model from the west entrance of Gund Hall, in accordance with an exemplary embodiment of the present invention.

FIG. 9 is a third diagram illustrating the 3-D virtual model from the interior of Gund Hall, in accordance with an exemplary embodiment of the present invention.

FIG. 10 is a fourth diagram illustrating the 3-D virtual model with several layers of Gund Hall removed, in accordance with an exemplary embodiment of the present invention.

FIG. 11 is a fifth diagram illustrating the 3-D virtual model with several additional layers of Gund Hall removed, in accordance with an exemplary embodiment of the present invention.

FIG. 12 is a sixth diagram illustrating the 3-D virtual model integrating situational awareness information, in accordance with an exemplary embodiment of the present invention.

FIG. 13 is a seventh diagram illustrating the 3-D virtual model providing proposed responses based on the situational awareness information, in accordance with an exemplary embodiment of the present invention.

FIG. 14 is an eighth diagram illustrating the 3-D virtual model providing a route through the structure based on the situational awareness information, in accordance with an exemplary embodiment of the present invention.

FIG. 15 is an ninth diagram illustrating the 3-D virtual model integrating additional situational awareness information, in accordance with an exemplary embodiment of the present invention.

FIG. 16 is a tenth diagram illustrating the 3-D virtual model with several floors peeled away, in accordance with an exemplary embodiment of the present invention.

FIG. 17 is an eleventh diagram illustrating the 3-D virtual model rotated and with several floors peeled away, in accordance with an exemplary embodiment of the present invention.

FIG. 18 is an twelfth diagram illustrating the 3-D virtual model with several floors peeled away and indicating various features located on the displayed floor, in accordance with an exemplary embodiment of the present invention.

FIG. 19 is a thirteenth diagram illustrating the 3-D virtual model with several floors peeled away and indicating additional features located on the displayed floor, in accordance with an exemplary embodiment of the present invention.

FIG. 20 is a fourteenth diagram illustrating the 3-D virtual model with several floors peeled away and indicating additional features located on the displayed floor, in accordance with an exemplary embodiment of the present invention.

FIG. 21 is a diagram illustrating a 3-D virtual model as a photo-realistic representation of the structure, in accordance with an exemplary embodiment of the present invention.

FIG. 22 is a diagram illustrating a magnified or zoomed-in view of the 3-D virtual model, in accordance with an exemplary embodiment of the present invention.

FIG. 23 is a flowchart illustrating steps for providing situational awareness for a structure, in accordance with an exemplary embodiment of the present invention.

FIG. 24 is a flowchart illustrating steps for determining ingress and/or egress routes through the structure using the structural information and situational awareness information associated with the structure, in accordance with an exemplary embodiment of the present invention.

FIG. 25 is a flowchart illustrating steps for responding to an emergency, in accordance with an alternative exemplary embodiment of the present invention.

### DETAILED DESCRIPTION OF THE PREFERRED EMBODIMENTS

Exemplary embodiments of the present invention are directed to a computer-based system and method for providing real-time or near real-time situational awareness for a structure using three-dimensional modeling, referred to as the Emergency Response System or ERS. The ERS provides data visualization and communications for critical infrastructure assets. By integrating real-time or substantially real-time data via sensors and monitoring systems, the Emergency Response System can convey the pertinent building, human concentration/movement, and operational details that are critical in emergency and other crisis situations. The ERS includes functionality to integrate, capture and store such data for dissemination, interpretation, and communication. The ERS supports methodologies for rapidly comprehensible information displays and data visualization techniques to aid in the critical presentation schemes needed to make quick and informed decisions within high pressure, often chaotic, emergency situations involving multiple jurisdictions, protocols, and human communication methods.

More particularly, the ERS comprises a local, regional and/or national secure Web-based repository including infrastructure data, drawings and related information for all types of federal, state and local facilities. The Emergency Response System can address critical needs by focusing on those areas or facilities that are considered imminent targets. Such an Internet-accessible system can allow for rapid query searches and information retrieval from anywhere in the United States or abroad. Additionally, the ERS includes functionality that can accelerate the time taken to determine the impact and appropriate response needed to effectively contain situations and understand and minimize the effects on surrounding areas. Thus, all or substantially all local and infrastructure details from an area, no matter how damaged by attack or disaster, can still be substantially immediately accessible for defense, recovery, and relief efforts. Such information can be protected from exploitation using suitable security and encryption, thereby substantially eliminating access to those who might seek to use the information inappropriately.

The Emergency Response System can provide vital static and real-time (or near real-time) infrastructure data displayed in three-dimensional (3-D) models of individual buildings, campuses, partial or entire portions of cities and the like and their immediate surroundings. Thus, the ERS can provide detailed 3-D virtual models of buildings, facilities and other structures, highlighting ingress and egress routes, existing emergency assets, digital photographs, vital utility shut-off valve locations, and multi-layered decision support information to address the critical need for the most salient information when responding to emergencies. Exemplary embodiments of the present invention can be used by first responders, building owners, facilities management, emergency management agency personnel, government agencies (e.g., DHS, GSA, DIA, DOD, FEMA and the like) and other like personnel and organizations. The ERS includes an interactive database, graphical user interface, and communication mechanisms for rapidly disseminating critical infrastructure data to all levels of personnel involved before, during, and after an emergency. The ERS can provide increased information sharing from on- and off-site personnel to provide enhanced situational awareness, improved resource allocation and deployment, and better communication and coordination during an emergency.

Once a building is constructed, the plans or other architectural schematics are usually put or stored away and generally not referenced until after an event occurs that requires inspection of these documents. However, by collecting, collating, and displaying such information in 3-D virtual models tied to rich-content databases, the Emergency Response System can provide clear and informative views, and actionable data can be represented to emergency personnel to assist in their critical mission duties. Additionally, with the integration of real-time or near real-time sensor data gathered from individual locations, enhanced visual and building-specific situational data can be made available.

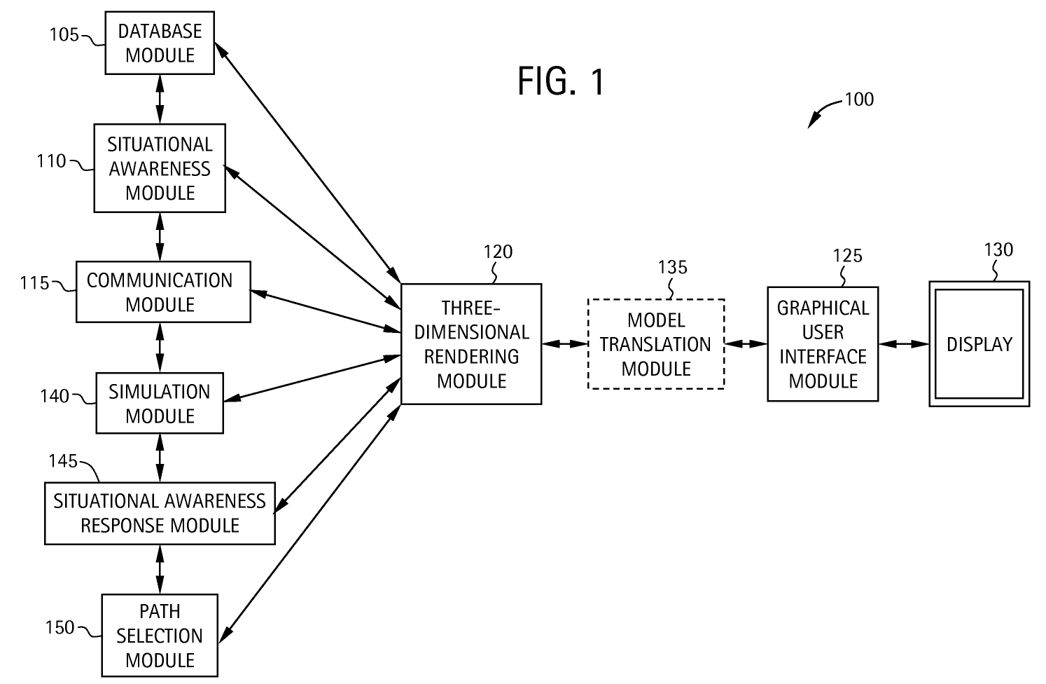

These and other aspects and embodiments of the present invention will now be described in greater detail. FIG. 1 is a diagram illustrating a system 100 for providing real-time or near real-time situational awareness for a structure, in accordance with an exemplary embodiment of the present invention. As used herein, a “structure” can include any suitable type of building, facility, dwelling, shelter, construction or other suitable place for human activity, and can include individual buildings, facilities or the like or collections thereof (e.g., a campus, partial or entire portions of towns or cities, and the like). The system 100 includes a database module 105. The database module 105 is configured to store structural information associated with the structure. As discussed below, the structural information associated with the structure is used by the system 100 to render or otherwise construct 3-D virtual models of the structure. As used herein, “structural information” includes architectural, engineering, construction, security information, emergency equipment systems and other like information related to the structure, as well as any other suitable types of planning, design, specification, and other like information that is capable of describing or otherwise providing or portraying the layout and design (both internal and external) of the structure from which a detailed 3-D virtual model of the structure can be constructed.

The database module 105 can be comprised of any suitable type of computer-readable or other computer storage medium. According to an exemplary embodiment, the database module 105 can be comprised of any suitable type of direct-attached storage (DAS), network-attached storage (NAS), or storage area network (SAN) system, such as those offered by EMC Software of Hopkinton, Mass. (e.g., the DiskXtender family of products), including any suitable type of document or content management system (e.g., the Documentum 5 Platform offered by EMC Software).

The structural information associated with the structure can be gathered or otherwise collected from any appropriate number of suitable sources, including architectural, engineering and construction information related to the structure. For example, structural information can be obtained from the structure's owner, i.e., the individual or organization that holds the ownership rights to the physical real estate property or physical asset. The information can also be project based, i.e., any new development or renovation/remodeling of a structure that requires planning, design, documentation and/or construction activities.

In addition, the structural information can include survey photos or drawings, such as, for example, any photographic record or drawing, whether generated manually or by computer, that describes a physical space or property with precise measurements and that records the specific settings of the photographic or measuring device. Such photographic or drawing information can include both on-ground surveys as well as aerial and satellite based photographic imaging. A photographic or measuring device can include traditional as well as digital cameras or video equipment. Survey documentation further includes precise geo-positioning of key features of the structure to describe the structure's unique position on earth.

The structural information can also include architectural documents. Such documents can include documents generated by a registered professional or organization engaged in the planning, design, specification, and documentation of real estate projects. For example, as part of standard practice, architects produce a variety of documentation and models to analyze and communicate design solutions. However, such documentation and models are not configured to be integrated into a full building 3-D virtual model. Such documentation can include, for example, manual and CAD drawings, specifications, schedules, and renderings.

Structural documentation can also form part of the structural information stored or otherwise maintained in the database module 105. Such structural documentation can include, for example, documentation generated by any registered professional or organization engaged in the planning, design, specification, and documentation of the structural components of a real estate project or other physical asset. For example, structural engineers produce as part of standard practice a variety of documentation and models to analyze and communicate design solutions.

The structural information can further include documentation related to the electrical, mechanical, and/or plumbing features of the structure. For example, any registered professional or organization engaged in the planning, design, specification, and documentation of the mechanical systems, e.g., heating, ventilation, and air conditioning (HVAC) systems, electrical systems, and/or plumbing systems of a structure can generate documents that can be used as described herein. As part of standard practice, such professionals can produce a variety of documentation and models that can be used, for example, to analyze and communicate design solutions.

Any registered professional or organization engaged in the planning, design, specification, and documentation of the interior design and/or the finishes, furniture and equipment components (including emergency equipment) of a structure can also generate documentation or information that can be stored in database module 105 and used as described herein. For example, as part of standard practice, interior designers produce a variety of documentation and models to analyze and communicate design solutions. Security consultants can also produce documentation and models for security systems in a structure. Emergency management personnel or consultants can also generate documentation and models for emergency equipment and systems on, in, or around the structure. All such documentation and models can be gathered or otherwise collected and stored or maintained in the database module 105.

Information related to the landscape can also be obtained and stored in the database module 105. For example, any registered professional or organization engaged in the planning, design, specification, and documentation of the landscape components of a structure, including any topographical changes, planting plans, site furniture and lighting, and environmental graphics, can produce useful documentation or generate useful information. For example, as part of their standard practice, landscape architects can produce a variety of documentation and models to analyze and communicate design solutions.

In addition, a variety of other consultants can participate in a real estate or other physical asset project, including, but not limited to, civil engineers, transportation and traffic engineers, conveying systems consultants or engineers, life, safety, and security analysis consultants or engineers, information technology professionals, graphics consultants, lighting, acoustics and audio/visual consultants or engineers, asbestos abatement specialists, water feature consultants and the like. As part of their respective standard practices, all such consultants can produce a variety of documentation and models to analyze and communicate design solutions that can be obtained and stored in the database module 105 and used as described herein.

Any registered professional or organization engaged in the oversight and construction of a physical real estate or other asset project, based on the contract documentation provided by an aggregate team of consultants, such as those described previously, can produce, as part of standard practice, documentation related to schedules, quantity take-offs, accounting reports, shop drawings, and construction progress reports, as well as documentation related to the installation and construction of all building component and assemblies. All such information and documentation can be obtained, collected or otherwise gathered and then stored in database module 105 for use as described herein. Such information can also include information produced by various sub-contractors. For example, any registered professional or organization can be engaged as a sub-contractor to construct one portion, aspect or instance of a larger physical real estate or other asset project, based on the contract documentation provided by an aggregate team of consultants, such as those described above. A sub-contractor usually reports to a primary contractor and delivers schedules, quantity take-offs, shop drawings, construction progress reports, and as-built documentation, in addition to information related to the installation and construction of building components and assemblies.

Manufacturers can also produce documentation or information that can be stored in database module 105 and used as described herein. For example, any qualified professional or organization engaged in the production of building materials and components can produce information based on which 3-D virtual models can be constructed. In addition to delivering the physical materials and/or products, a manufacturer delivers, as part of standard practice, specifications, photographs, and detailed drawings of their physical products. Manufacturers can also provide additional information about how their products could or should relate to complementary products.

In sum, the structural information associated with the structure can be obtained from any suitable number of different and varied sources, and all such information can be collected and gathered and then stored or otherwise maintained in the database module 105. Accordingly, the database module 105 can be comprised of a relational database of detailed 3-D virtual structure models and suitable underlying component databases.

The system 100 includes a situational awareness module 110. The situational awareness module 110 is configured to gather, collect or otherwise receive situational awareness information associated with the structure. As used herein, “situational awareness information” can include any suitable type of information that can be used to perceive the elements in an environment, to comprehend the meaning and relative importance of those elements, and to project the status of those elements into the near future. For example, the situational awareness information can include sensor data received from sensors located in, on and around the structure. Such sensors can include, but are not limited to, smoke sensors, infrared or flame sensors, audio sensors, video sensors, video surveillance cameras and/or closed-circuit television, motion sensors, gas sensors, biotelemetry, performance data from HVAC and mechanical systems or any other suitable type of information capable of being provided by instrumentation in, on, around and/or within the structure. Situational awareness information can also include information associated with an emergency or other critical situation occurring in or around the structure, such as alarm or alert notifications of fire, explosion, flood, burglary or trespass, and the like, or tactical information on the nature and extent of the emergency or other critical situation.

The situational awareness information can further include environmental information associated with the structure. According to exemplary embodiments, the situational awareness module 110 can interface not only to the instrumentation in, on or around the structure, but also to external or outside information sources, such as news, weather or any other suitable types of real-time or near real-time data feeds (e.g., XML-based data feeds). For example, weather information from an appropriate external weather information source can be used for assessing the weather conditions immediately around or within the vicinity of the structure. Such situational awareness information can be gathered by the situational awareness module 110 in real-time or near real-time from the structure and external sources to provide up-to-date information for use in situational assessment. Such information can be stored (in either the situational awareness module 110 or the database module 105) for later retrieval to provide historical situational awareness data (e.g., historical sensor data).

To facilitate the gathering or collection of situational awareness information, the system 100 can include a communication module 115 in communication with the situational awareness module 110. The communication module 115 is configured to transmit and receive situational awareness information associated with the structure (e.g., sensor data from the building instrumentation, tactical or operational information from personnel at the scene, and the like) and suitable external or other outside sources. The communication module 115 can be comprised of any suitable type of transceiver or communication element, device, circuit or system that is capable of communicating such information either wirelessly or through wired connections, or any combination thereof, using any suitable type of transmission protocol or standard. The communication module 115 can provide the system 100 with the ability to share situational awareness information with other systems, such as, for example, crisis command or incident management systems, integrated incident management systems or the like, to allow for collaborative situation assessment and response planning between such systems and various personnel (e.g., personnel from different emergency response agencies).

To facilitate such collaboration, the situational awareness module 115 can be configured to transform the situational awareness information into a normalized or uniform format used by the system 100 after receipt, and transform such information into the format recognized by the external system prior to transmission. For example, the situational awareness information can include an identification (e.g., a unique alphanumeric designation, a unique IP address or the like) of the system supplying such information. An appropriate look-up table can be maintained by the situational awareness module 110 that maps the identification of the system supplying the information to the type of information format supported by such system. Upon receipt of such information, by looking up the identification in the look-up table, the situational awareness module 110 can “understand” the format used by the other system and then perform the appropriate transformations on the data, if necessary, to convert the information into the format used by the system 100. Prior to transmission, the situational awareness module 110 can look up the identification of the system to which the information is to be sent, and retrieve formatting or transform information for that system. Such transformation can be algorithmic (e.g., transcoding of video data from one format to another) or format-specific (e.g., all numbers must have two decimal places), and such transformation or formatting information can be included in or referred to by the look-up table to allow the situational awareness module 110 to perform the required transformation or conversion. The situational awareness module 110 can then transform, transcode, convert, format or re-format the data, as necessary, to accommodate the system 100 or the external system. Those of ordinary skill in the art will recognize that other mechanisms can be used to perform such data transformations or formatting. According to an alternative exemplary embodiment, the communication module 115 can perform such look-ups and transformations on behalf of the situational awareness module 110 to abstract such data format differences away from the situational awareness module 110 and the rest of system 100.

The system 100 includes a 3-D rendering module 120 in communication with the database module 105, the situational awareness module 110 and the communication module 115. The 3-D rendering module 120 is configured to render a 3-D virtual model or digital representation of the structure utilizing the structural information associated with the structure that is stored in the database module 105.

Any suitable system or method can be used by the 3-D rendering module 120 to create, generate or otherwise render the 3-D virtual model of the structure. For example, the structural information for individuals features or objects of the structure (e.g., walls, windows, doors, corridors, ceilings or roofing, rooms or other enclosures, furniture, and the like) can be used to create 3-D virtual component models of each of those individual objects. For purposes of illustration and not limitation, 3-D virtual component models of walls can be created from the structural information associated with the walls of the structure using suitable 3-D rendering algorithms to create the 3-D virtual wall component models. In addition, such 3-D virtual wall component models can also include 3-D virtual component models of systems that reside in those walls, such as plumbing systems, electrical systems, mechanical systems, environmental systems, emergency equipment systems and the like of the structure that can be obtained from the structural information to create the corresponding 3-D virtual component models of those system.

Continuing with the present illustration, 3-D virtual component models of windows can be created from the structural information associated with the windows of the structure using suitable 3-D rendering algorithms to create the 3-D virtual window component models. Such individual 3-D virtual component models can be created for each feature or asset of the structure. These individual 3-D virtual component models can then be combined by the 3-D rendering module 120 to create the entire 3-D virtual model of the structure and any and all 3-D views of the exterior and interior layout of the structure. Once the 3-D virtual component models for each of the structure's features or assets have been generated, the separate 3-D virtual component models can be integrated by the 3-D rendering module 120 to generate a geo-positioned, three-dimensional digital representation of the structure, also referred to as the 3-D virtual structure model. The 3-D virtual component models and the 3-D virtual structure model can comprise any suitable 3-D representation of the given components and/or structure, from simple wire-frame models to more complex and detailed photo-realistic representations (e.g., illustrating textures of materials and the like), depending upon the needs of the users, the intended use of the system 100, and other like factors.

The 3-D virtual component models and the 3-D virtual model of the structure generated by the 3-D rendering module 120 can include, for example, several software/computer generated models. In other words, the systems and methods described herein do not necessarily make use of any single software application or suite of software applications in the development of the 3-D virtual component and structure models. Thus, exemplary embodiments of the present invention can make use of an integrated virtual model based on several different underlying models that are integrated by the 3-D rendering module 120. In other words, the 3-D virtual component models and 3-D virtual structure model can be generated using a suitable 3-D solution that is capable of describing real world geometries including a third dimension, for example, as solid models. Such solutions can be capable of performing Boolean and other algorithmic operations that allow for the creation of complex solids. In general, 3-D software solutions can provide for digital documentation of the geometric properties of objects and typically position objects relative to each other using insertion points as the basis for relational positioning.

Photo modeling solutions that allow for the creation of solid 3-D geometries from photographs, in the absence of any CAD or manually generated documentation, can also be used to generate the 3-D virtual component models and 3-D virtual structure model. Photo based modeling can, for example, be based on perspectival science. If a field of view is known and one dimension within the photograph is accurate, then all geometric dimensions can be related to that dimension and, therefore, the entire environment can be extrapolated. In the case of a photographic camera, the focal length setting determines the field of view. For example, a focal length of 55 mm can be considered ideal, as that is both a standard type lens as well as the closest approximation of the human eye. A photo modeling solution can also be used to capture the image of materials and surfaces of real world objects.

In addition, graphics solutions can also be used to adjust the visual accuracy of real world materials and finishes. The resulting corrected material images can form the basis of visual material maps that can then be applied to the 3-D virtual component models and/or the 3-D virtual structure model.

Photometric solutions can be used to apply real world lighting characteristics, as defined by the Illuminating Engineering Society, to light fixture components within the 3-D virtual component models and the 3-D virtual structure model. The process of calculating the actual light distribution within a 3-D environment can be based on various techniques. For example, one technique, called ray-tracing, traces the light emitted from a source and tracks it until it bounces against another solid, at which point the ray is processed. The object's material properties, such as, for example, absorption/reflectivity, can then be used to further trace the ray until it bounces against another solid object. Such a method can be “demand-driven,” in that the light rays are calculated after a view has been established, and, therefore, the angles of polygons defining the associated 3-D environment are known, allowing for the ray-tracing to occur. Another technique is called radiosity that is a “data-computational” method of light calculation. Radiosity is based on preset intensity and material specifications of each object within the environment being modeled. With such information, the effect of light sources on each object can be calculated, as well as the light and color impact due, for example, to the proximity of two objects. Another technique that can be used is global illumination. Such a technique takes into account not only the light coming directly from light sources, but also the reflection of any light off of any surface in the 3-D virtual component models or the 3-D virtual structure model.

Additionally or alternatively, laser/light scanning can be used. Such a method uses lasers, or some other photographic-light-based technology, to scan real world objects to develop an integrated solution of geometric description of a 3-D object and its associated material image map. Various levels of accuracy can be achieved depending on the specific technology as required by a particular implementation.

A Global Positioning System (GPS) solution can be used to identify a specific digital point in a 3-D virtual component model or the 3-D virtual structure model as being precisely positioned as a unique instance on Earth. Such a solution can also be used to mark the specific period of time that that 3-D virtual component model or 3-D virtual structure model is located in such position.

Various types of metadata can also be used in the creation or rendering of the 3-D virtual component models and the 3-D virtual structure model. For example, a suitable metadata editor can be used to add, edit, and manage non-geometric or tabular data that has been associated with 2-D or 3-D geometric descriptions of 3-D objects. Such an editor can be used, for example, to link a 3-D virtual component model or the 3-D virtual structure model to other types of applications including databases, cost estimating, project management, scheduling software and the like.

A physical construction methodology can also be used in the rendering of the 3-D virtual structure model by the 3-D rendering module 120. The physical construction methodology refers to the complete set of processes and resources required to physically build a specific real estate property or structure on a particular location on Earth. Such a methodology can be dependent on the material and handling specifications intrinsic to the material and as described by the manufacturer(s) of that material.

The tools, techniques, and solutions described above can be used to generate models or other structures or data that can then be used by the 3-D rendering module 120 to generate the 3-D virtual component models that can be integrated or otherwise assembled to render the geo-positioned 3-D virtual model of the structure. Alternatively, the 3-D rendering module 120 can use the structural information associated with the structure to create the 3-D virtual structure model directly, without rendering or using individual 3-D virtual component models. However, other methods for rendering the 3-D virtual model of the structure (whether comprised of 3-D virtual component models or not) can be used, such as those described in, for example, U.S. Patent Application Publication No. 2005/0131657 to Hsaio Lai Sean Mei, entitled “Systems and Methods for 3D Modeling and Creation of a Digital Asset Library” and filed on Dec. 16, 2003, the entire contents of which are hereby incorporated herein in their entirety.

According to an exemplary embodiment, the REVIT™ series of products, in particular, the REVIT™ Building software system, distributed by Autodesk, Inc. (San Rafael, Calif.) can be used by the 3-D rendering module 120 to create the 3-D virtual model of the structure, and any 3-D virtual component models of which the 3-D virtual structure model can be comprised. REVIT™ Building is a building information modeling (BIM) system that provides a conceptual modeling and design environment that takes any overall building form described by the user and maps it to real-world entities. For example, through concept modeling, the user can create a building shell and then select faces to design walls, roofs, floors and curtain systems. REVIT™ Building provides a fully-integrated building information model with a single project database for simplified project management. Model linking is supported for connecting separate models into a single integrated project. For example, “families” (e.g., a door) can be created with nested components (e.g., various hardware sets) by specifying the attributes or characteristics of each component. From such information, the families can be created graphically and combined with other graphical families to create the overall structure. REVIT™ Building also allows the user to view the individual components and overall structure in three dimensions, for example, using raytracing and radiosity for 3-D visualizations. However, skilled artisans will recognize that other suitable software applications or techniques can be used to create the 3-D virtual model of the structure according to exemplary embodiments, such as, for example, SKETCHUP™ offered by Google, Inc. (Mountain View, Calif.), VIRTUAL BUILDING™ by Graphisoft U.S., Inc. (Newton, Mass.), VECTORWORKST™ by Nemetschek N.A. (Columbia, Md.), the Building suite of software products (e.g., MICROSTATION™, POWERDRAFT™, POWERMAP™ and the like) by Bentley Systems, Inc. (Exton, Pa.), or any other appropriate software applications or techniques.

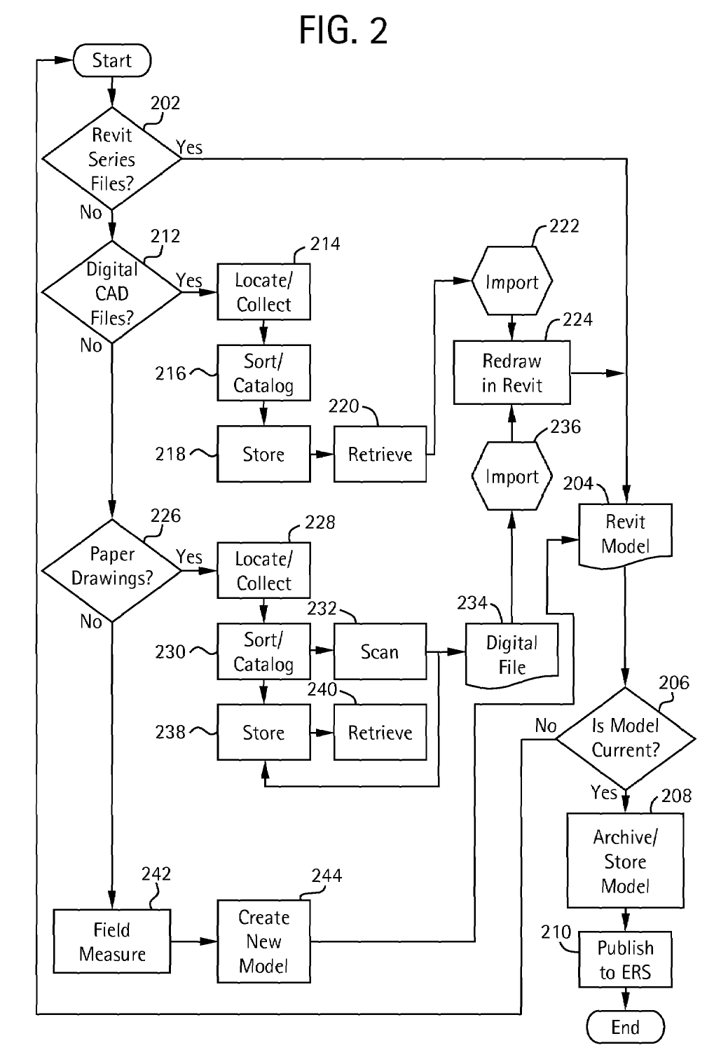

For the exemplary embodiment in which the 3-D rendering module 120 uses REVIT™ Building, FIG. 2 is a flowchart illustrating steps for collecting structural information associated with a structure for use in rendering the 3-D virtual model of the structure using REVIT™ Building, in accordance with an exemplary embodiment of the present invention. In step 202, a determination is made as to whether or not the structural information is in the form of a REVIT™ series (digital) file. If so, then in step 204, the REVIT™ model is generated from or otherwise updated with the structural information contained in the REVIT™ series files. In step 206, a determination is made as to whether or not the REVIT™ model is current, in other words, whether or not there is no additional structural information to collect for model at that time. If so, then in step 208, the model is archived or otherwise stored (e.g., for purposes of backup), and in step 210 the model is passed to the GUI module 125 for display to the user via display 130, as described below (a translation of the model into a different data format supported by the GUI module 130 and display 130 may need to be performed by model translation module 135, as described below). However, in step 206, if it determined that the model is not current, then the process returns to step 202.

Back in step 202, if it is determined that the structural information is not in the form of a REVIT™ series file, then in step 212, a determination is made as to whether the structural information is in the form of digital CAD files. If so, then in step 214, the digital CAD files are located or otherwise collected. In step 216, the collected digital CAD files are sorted and cataloged. In step 218, the sorted/cataloged digital CAD files are stored (e.g., for purposes of backup), and then retrieved in step 220. In step 222, the digital CAD files are imported into the REVIT™ model, and the newly-imported structural information is redrawn in the REVIT™ model in step 224. The method continues with step 204, as described above.

Back in step 212, if it is determined that the structural information is not in the form of digital CAD files, then in step in step 226 a determination is made as to whether the structural information is in the form of paper drawings. If so, then in step 228, the paper drawings are located or otherwise collected. In step 230, the collected paper drawings are sorted and cataloged. In step 232, the sorted/cataloged paper drawings are scanned to create corresponding digital files in step 234. In step 236, the generated digital files are imported into the REVIT™ model, and the newly-imported structural information is redrawn in the REVIT™ model in step 224. The method continues with step 204, as described above. However, after step 230, an iterative process can be used, for example, to recreate the digital files of the structural information if necessary. For example, in step 238, the paper drawings can be stored (e.g., for archival purposes), retrieved in step 240, and then scanned again in step 232 to recreate the corresponding digital files. The method can return to step 238 to repeat the process as necessary.

Back in step 226, if it is determined that the structural information is not in the form of paper drawings, then in step 242, field measurements of the structure can be taken to generate the structural information necessary for building the three-dimensional REVIT™ model. In step 244, a new REVIT™ model can be created from the structural information measured in step 242. The method continues with step 204, as described above. The steps illustrated in FIG. 2 can be repeated any suitable number of times to collect any and all structural information associated with a structure for building the REVIT™ model. Those of ordinary skill will recognize that similar steps can be undertaken for collecting structural information for use in rendering 3-D virtual models using data formats or digital models other than that supported by REVIT™ Building.

Returning to FIG. 1, the structural information used by the 3-D rendering module 120 to render the 3-D virtual structure model can include attributes of objects associated with the structure. Such attributes can include characteristics of the object, such as, for example the type of object, length, width, height and weight of object, the material(s) of which the object is composed and other data or information that can be used to suitably describe and define the object. For purpose of illustration and not limitation, an object associated with the structure can be a window, and the attributes of window can include the type of window (e.g., interior or external, sliding or plate glass and the like), the dimensions of the window (e.g., length and width), location of the window in the wall, the type of glass used in the window, and other like attributes. As will be recognized by those of ordinary skill in the art, the attributes of the object will depend of the nature and type of object to be described by its attributes.

As each object or component within the structure can be described by its attributes, and the objects or components assembled to create a three-dimensional virtual visual representation of the overall structure, various types of 3-D virtual models can be used to store and present such information. According to one exemplary embodiment, the 3-D virtual model can comprise a parametric 3-D virtual model. With such a parametric model, a modification to one or more attributes of a first object can be configured to cause the 3-D rendering module 120 to modify one or more attributes of at least a second object associated with the first object within the parametric 3-D virtual model. For purposes of illustration and not limitation, a door can comprise an object, with attributes describing the door and its position within a wall. Using parametric modeling, if the dimensions of the door are altered, then the dimensions of the wall in which the door is incorporated can be correspondingly altered automatically by the 3-D rendering module 120. For example, if the height and width of the door are altered, then the 3-D rendering module 120 can automatically alter the dimensions of the wall around the door so that the door can appropriately “fit” into the wall. Thus, attributes of objects can also be used to describe other objects that interact or interrelate with the original object, thereby linking objects together (e.g., the door within the wall).

Additionally or alternatively, the objects can comprise “smart” objects. In other words, the 3-D rendering module 120 can be configured to render the impact or result of an action directed to a smart object using the attributes of the smart object and the nature of the action. For purposes of illustration and not limitation, an attribute of a window can be its resistance to blasts or concussive force, such as the maximum blast force that the window can withstand. Thus, if a simulated or actual blast occurs in the vicinity of the window, and the strength of the blast is known or can be calculated, then the 3-D rendering module 120 can render the effect of the blast on the window. For example, if a blast occurs and the blast is at or below the maximum blast force that the window can withstand, then the 3-D rendering module 120 can render the window as intact. However, if a blast occurs and the blast is above the maximum blast force that the window can withstand, then the 3-D rendering module 120 can render the window as being “blown out” or otherwise destroyed. Thus, smart objects can be used to determine the effects that the environment and actions occurring within that environment have on the smart objects and the structure in general. Such smart objects can be used to create an “intelligent” 3-D virtual model in which the 3-D rendering module 120 can “know” (i.e., appropriately calculate or compute) the effect of actions directed at or occurring to objects in, on or around the structure or to the structure itself to provide. The effects of those actions can then be displayed to the user as part of the overall situational awareness provided by the system 100.

According to exemplary embodiments, the 3-D rendering module 120 is further configured to integrate or otherwise incorporate into the 3-D virtual model of the structure the situational awareness information associated with the structure that has been gathered or otherwise collected by the situational awareness module 110. For example, the 3-D rendering module 120 can create appropriate graphical overlays to integrate or superimpose the situational awareness information into or on the 3-D virtual model of the structure. For example, according to an exemplary embodiment, the 3-D rendering module 120 can be configured to render in the 3-D virtual model the sensor data received from the sensors or other building instrumentation situated in, on, around or within the structure. For example, each sensor or other instrumentation located in, on or around the structure can be characterized as an object and described by its concomitant attributes (e.g., type of sensor, make, model, location, and the like). Situational awareness information received by the situational awareness module 110 can be passed to the 3-D rendering module 120. The 3-D rendering module 120 can appropriately modify the attributes of the object based on the received situational awareness information.

For purposes of illustration and not limitation, the object can be a fire sensor in a certain room on a certain floor of the structure. The situational awareness information received indicates that the fire sensor has been activated and the sensor indicates that that the temperature in the room is 225° F. The 3-D rendering module 120 can use such information to modify or otherwise update the attributes associated with the given fire sensor. The fire sensor can be rendered by the 3-D rendering module 120 using the updated attributes, for example, by changing the color, highlighting, blinking or other visual and/or audio indication of the fire sensor in the 3-D virtual model. In addition, sensor data received from the fire sensor (e.g., the temperature in the room) can be rendered near or adjacent the fire sensor to provide an up-to-date situational assessment of the structure and the given room in particular. According to exemplary embodiment, each, any combination or all of the sensors rendered within the 3-D virtual model of the structure can be “linking points” for allowing the user to access information associated with the sensor. For example, when a user selects the linking point (e.g., by clicking on the virtual representation of the sensor with a mouse or other computer pointing device), the sensor data received from the corresponding sensor can be displayed to the user (e.g., the temperature in the room as received from the fire sensor) in a separate window, pop-up or callout. Linking points can also be used to direct the user to or provide the user with information from auxiliary or additional sources (e.g., websites, databases and the like). However, according to exemplary embodiments, any textual or graphical situation awareness information can be displayed or otherwise provided to the user in such a manner. For example, a video surveillance camera can be represented as an object within the 3-D virtual model and also serve as a linking point. Consequently, when the user selects or otherwise clicks on the virtual representation of the video surveillance camera in the 3-D virtual model (i.e., its linking point), the video data from the camera (e.g., still pictures, streaming video or the like) can be displayed to the user (e.g., in a pop-up window).

Additionally, if the situational awareness information comprises environmental information (e.g., weather data received from a weather feed), the 3-D rendering module 120 can be configured to render in the 3-D virtual model the environmental information to display the environment in which the structure resides. For example, if the weather data indicates that it is raining around the structure, the rain can be considered another object with which attributes (e.g., humidity, rate of falling rain and the like) can be associated. The 3-D rendering module 120 can then render a three-dimensional virtual representation of the rain around the structure using the rain object and its attributes. Other situational awareness information can be integrated into the 3-D virtual model of the structure by creating new objects and associated attributes to accommodate the information, or associating or otherwise updating existing objects and their attributes with the data.

The 3-D rendering module 120 can be configured to render in the 3-D virtual model the locations of and information associated with any and all objects situated in, on or around the structure, including people or other personnel located at the structure. In such a way, the movements of individuals in and around the structure can be updated, tracked and monitored. For example, each person can be an object with associated attributes (e.g., name, agency association, such as fireman or policeman, GPS coordinates and other like information). By relaying GPS coordinates from each person to the situational awareness module 110 (via the communication module 115), the 3-D rendering module 120 can update the attributes of each “object” (i.e., person) with the new coordinates to effectively track the movements of each or any person at the scene. If each or any person is equipped with health monitoring equipment (e.g., to measure and monitor heart rate, blood pressure, and the like), such health information can be provided to the 3-D rendering module 120 (via the situational awareness module 110) to update the attributes of the “object.” Such information can be provided to the user, for example, as a linking point that can cause the information to be displayed in a pop-up window upon selection. Additionally or alternatively, the health information can be used by the 3-D rendering module 120 to create warnings or alarms associated with the “object,” such as a change in color of the object if the heart rate of the individual drops below or rises above a predetermined level indicating that the person may be in distress or danger. In such a manner, the 3-D rendering module 120 can integrate any or all real-time or near real-time situational awareness information into the 3-D virtual model for display to the user for situation assessment and response planning.

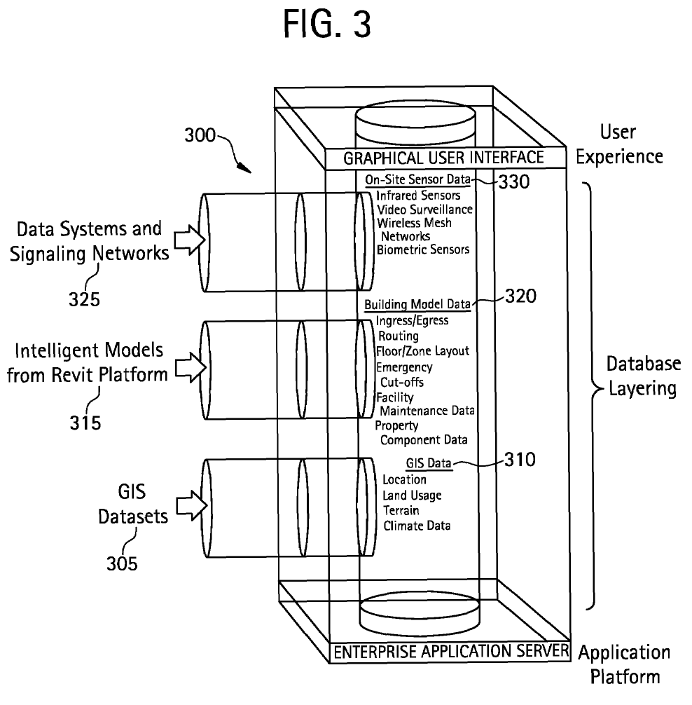

Thus, the 3-D virtual model of the structure can be comprised of structural information, situational awareness information, and any other suitable type of information for creating an accurate, geo-positioned 3-D virtual model of the structure that can be used for situational assessment and response planning. FIG. 3 is a diagram illustrating the various types of information that can comprise the 3-D virtual model 300, in accordance with an exemplary embodiment of the present invention. For example, Geographic Information System (GIS) datasets 305 can provide appropriate GIS data 310, such as, for example, location, land usage, terrain, climate data and the like. Layered on the GIS data 310, intelligent model data 315 from the REVIT™ Building platform can provide appropriate building model data 320, such as, for example, ingress/egress routing, floor/zone layout, emergency valve cut-offs, facility/maintenance data, property/component data, and the like. Layered on the building model data 320 and GIS data 310, suitable data system and signaling networks 325 can provide appropriate on-site sensor data 330, such as, for example, infrared sensors, video surveillance, wireless mesh networks, biometric sensors and the like. Such a layered database of information can comprise the 3-D virtual model 300 that can be displayed to a user through a suitable graphical user interface.

Returning to FIG. 1, the system 100 includes a graphical user interface (GUI) module 125 in communication with the 3-D rendering module 120. The GUI module 125 is configured to display to the user the 3-D virtual model of the structure integrating the situational awareness information associated with the structure. The GUI module 125 can be comprised of any suitable type of user interface capable of displaying the 3-D virtual model, including the textual and/or graphical information thereof, to a user. For example, the GUI module 125 can be configured to display the 3-D virtual model through a suitable Web browser (e.g., Internet Explorer, Netscape, Firefox, Safari, Opera, or any other suitable Web browser) on a display 130. According to an exemplary embodiment, the 3-D virtual model of the structure that incorporates the situational awareness information associated with the structure can be displayed over a network, such as any suitable type of intranet or internet. For example, the 3-D virtual model can be remotely displayed through a suitable Web browser over the Internet or World Wide Web onto a display 130 by the GUI module 125. However, according to an alternative exemplary embodiment, the GUI module 125 can be configured to display the 3-D virtual model of the structure with the situational awareness information associated with the structure on any suitable type of portable display device, such as a personal digital assistant (PDA) or the like. Thus, the display 130 can be comprised of any suitable type of portable or fixed display device that is capable of displaying the textual and graphical information of the 3-D virtual model to the user.

As the 3-D module can be displayed on different types of displays 130 using different types of user interfaces, the system 100 can optionally include a model translation module 135 in communication with the 3-D rendering module 120 and the GUI module 125. The model translation module 135 is configured to convert or otherwise transform the 3-D virtual model rendered by the 3-D rendering module 120 into a format displayable by the GUI module 125 on the display 130. For example, the model translation module 135 can use appropriate conversion algorithms or routines and/or look-up table mappings to convert the 3-D virtual structure model from the graphical and/or data format used by the system 100 into the graphical and/or data format used by the user interface on the display 130, and vice versa. The system 100 can support any appropriate number of separate user interfaces and displays 130, and the model translation module 135 can be configured to convert or otherwise translate the 3-D virtual model into the data format supported by each user interface and display 130 (e.g., a one-to-many relationship). Alternatively, each user interface and display 130 can have a separate model translation module 135 to perform the necessary conversion.

For example, according to an exemplary embodiment, the GUI module 125 can comprise any suitable type of GIS. A GIS is a system for creating, storing, analyzing and managing spatial data and associated attributes. According to one exemplary embodiment of the present invention, the GUI module 125 can comprise the GOOGLE™ Earth application offered by Google, Inc. (Mountain View, Calif.). GOOGLE™ Earth is a 3-D software application that combines satellite imagery, maps and GOOGLE™ searching to provide users with access to the world's geographic information. Using GOOGLE™ Earth, a user can point and zoom to any place on the planet (e.g., a specific address) that the user wants to explore. Satellite images and local facts for the given address or location are then zoomed into the view presented to the user. However, skilled artisans will recognize that other suitable software applications or techniques can be used to display the 3-D virtual model of the structure according to exemplary embodiments.

For example, according to an exemplary embodiment, the REVIT™ Building software application can be used to create the 3-D virtual model of the structure, and the GOOGLE™ Earth software application can be used to display the 3-D virtual model to the user via display 130. Accordingly, GOOGLE™ Earth can be used to navigate and view the 3-D virtual model, and the GOOGLE™ searching functionality can be used to search any aspect of the 3-D virtual model. More particularly, the 3-D rendering module 120 can use REVIT™ Building to create the 3-D virtual model of the structure, and the resulting 3-D virtual model can then be loaded or otherwise imported into the GOOGLE™ Earth application that can be used by the GUI module 125. However, the data format of the 3-D virtual model generated by REVIT™ Building may not be supported by GOOGLE™ Earth and vice versa. Consequently, to display the 3-D virtual model via GOOGLE™ Earth, the model translation module 135 can be used to convert the 3-D virtual model from the data format supported by REVIT™ building into the data format supported by GOOGLE™ Earth, and vice versa. As described previously, the model translation module 135 can using appropriate conversion, translation or transcoding algorithms and/or look-up table mappings between the different formats to convert the 3-D virtual model from one data format to another. Of course, if the data format of the 3-D virtual model generated by the 3-D rendering module 120 is supported by or otherwise compatible with the user interface used by the GUI module 125 and display 130, the use of model translation module 135 may not be necessary.

The GUI module 125 is configured to display the 3-D virtual model of the structure and any information associated with that structure through an appropriate graphical user interface via display 130. For example, the GUI module 125 can be configured to display the attributes of each object associated with the structure to the user upon request, such as by presenting information on the attributes through callouts or pop-ups via linking points, as discussed above. Additionally or alternatively, by passing a mouse cursor or other computer pointer indicator over an object, a suitable callout or pop-up can be displayed to the user with information related to the given object.

The GUI module 125 is further configured to receive instructions from the user for navigating the 3-D virtual model to examiner the structure and the situational awareness information associated with the structure. In other words, suitable navigation buttons or controls (e.g., move up/down, move left/right, zoom in/out, rotate up/down, rotate left/right and the like) can be presented to the user in the graphical user interface displayed on display 130. The navigation controls can be used to alter the view of the 3-D virtual model so that the user can inspect any interior or exterior aspect of the 3-D virtual model at any suitable angle, elevation, distance, orientation or the like. The navigation instructions generated by the navigation controls can be processed by the GUI module 125 to provide the desired view of the 3-D virtual model to the user. For example, the GUI module 125 can be configured to display layers of the 3-D virtual model to the user for viewing structural elements (e.g., plumbing systems, electrical systems, mechanical systems, environmental systems, emergency equipment systems and the like) and internal layouts of the structure.

According to an exemplary embodiment, the GUI module 125 can be configured to allow the user to “peel away” the outer layers of the 3-D virtual structure model to view successively more interior views of the structure. For example, the user could remove the outer layer (outer walls and roof) of the structure to view the immediate interior of the structure. The user can them remove interior walls to view inner rooms and corridors of the structure. Additionally or alternatively, the user can “peel away” floors of the structure to view any lower floor. For example, after removing the outer layer of the structure, the user can remove the uppermost floor of the structure and then tilt and rotate the view to display the internal layout of the penultimate floor. In addition, to view structure elements located within walls or other objects within the structure, the GUI module 125 can be configured to allow the user to alter the opacity of any of the objects. For example, a navigation control in the form of a sliding lever or the like can allow the user to alter the opacity of an object (e.g., a wall) from 100% (fully opaque) to 0% (fully transparent) or any desired opacity in between. Other such controls can be provided to allow the user to view any and all aspects of the 3-D virtual model for situation assessment and response planning.

The system 100 can include other suitable modules to assist the user in such situation assessment and response planning. For example, the system 100 can include a simulation module 140 in communication with the 3-D rendering module 120. The simulation module 140 can be configured to generate simulations of situational awareness scenarios associated with the structure. Predetermined or “pre-canned” simulations can be supported by the simulation module 140. For example, certain fire alarms can be activated by the simulation module 140, e.g., by modifying or causing the 3-D rendering module 120 to modify the attributes associated with one or more fire sensors to indicate that a fire has been detected. Simulated situational awareness information, such as a fire temperature information, can be provided to the 3-D rendering module 120 for rendering in the 3-D virtual structure model and eventual display to the user. Suitable logging or recording functionality (e.g., a module included in the simulation module 140 or separate therefrom) can be used to record the response to the simulation and allow the user to playback the entire simulation at a subsequent time. Additionally or alternatively to “pre-canned” simulation scenarios, appropriate algorithms, Boolean or other logic functions, or even forms of artificial intelligence can be used to create random and dynamic simulations by the simulation module 140, depending on such factors as the need for simulation, the nature, types and complexity of simulation desired, the potential threats posed to the structure, and other like factors.

In any complex, dynamic and potentially life-threatening situation, it may become difficult for personnel to assess the situation quickly and form an appropriate response. To address such situations, the system 100 can include a situational awareness response module 145 in communication with the 3-D rendering module 120. The situational awareness response module 145 is configured to generate one or more proposed responses to an emergency situation or any other critical situation occurring in, on or around the structure. The situational awareness response module 145 can be comprised of suitable algorithms, Boolean or other logic functions or rules, neural networks, and/or forms of artificial intelligence that are capable of learning information about an event and, based on that information, formulate responses to counter the event. At one level, the situational awareness response module 145 can include appropriate look-up tables that can map situational awareness information to proposed responses. For example, if a fire sensor has been activated, then the situation awareness response module 145 can use the fire sensor activation event to look up the corresponding response(s), e.g., activate fire alarms, evacuate the structure, and notify the fire department and local authorities. Alternatively, suitable Boolean or other logic or rules can be used to propose responses to scenarios. For example, IF a fire sensor is activated AND the sensed temperate is above 150° F., THEN activate the fire alarm AND notify the fire department. The complexity of such logic or rules will depend on the nature of scenario and the number and types of responses there can be to such a scenario, as well as other like factors. More complex mechanisms, such as neural networks, can be adapted to “learn” how to respond to a particular scenarios. For example, according to an exemplary embodiment, the situational awareness module 145 can be in communication with the simulation module 140 to provide proposed responses to the simulated scenarios, for example, to allow such “learning” to take place and to refine these or other response algorithms.

As part of the proposed responses to either simulated or actual scenarios, it may be necessary to evacuate the structure while allowing response personnel to locate the source of the problem or event occurring within the structure. Consequently, the system 100 can be configured to provide an indication of efficient routes in, through and out of the structure. According to exemplary embodiments, the system 100 can include a path selection module 150 in communication with the 3-D rendering module 120. The path selection module 150 is configured to determine ingress and/or egress routes or other paths through the structure using the structural information and situational awareness information associated with the structure. For example, the egress routes can be evacuation routes from the structure for individuals located in the building, while the ingress routes can show response personnel the shortest route into and through the structure to the location of the event, emergency or other critical situation. The 3-D rendering module 120 is configured to render in the 3-D virtual model the ingress and/or egress routes for display to the user on the display 130 via the GUI module 125. In other words, the path selection module 150 can be configured to determine the shortest route between points within the structure, and the 3-D rendering module 120 can be configured to render in the 3-D virtual model the shortest route for display to the user.

Any suitable path selection algorithm can be used for determining routes in, around and through the structure between different locations or points. For example, the path selection module 150 can be configured to maintain a list of substantially all individual paths through the structure, including all individual paths along corridors, in and through rooms, up/down stairs and the like. A route between two points in the structure can be comprised of one or more individual paths that are connected or otherwise joined to form the contiguous route. Each of the individual paths through the structure can be assigned a path weight in accordance with, for example, the length of the individual path (e.g., shorter paths have lower or less weight than longer paths), the level of difficulty in traversing the individual path (e.g., a blocked path would have a high weight, while a clear path would have a low weight), and other like factors. Other similar factors for determining the “weight” of an individual path can be used.

Accordingly, the path selection module 150 can be configured to generate the total path weight of the route by summing the path weights of the individual paths that comprise the route. The 3-D rendering module 120 can be configured to render in the 3-D virtual model the route between the points in the structure with the lowest total path weight for display to the user. Alternatively, a predetermined number of alternative routes between the two points with the lowest path weights can be displayed to the user to provide the user with a selection of efficient routes. Modifications can be made to the path weights either automatically by the path selection module 150 or manually by the user to alter the route between the points in the structure (e.g., in response to changing situational awareness information, such as a path that suddenly becomes blocked). In addition to displaying the proposed route or routes through the structure, the path selection module 150 can be configured to calculate distance measurements for each of the proposed ingress and egress routes through the structure for display to the user (e.g., by adding up the length of each individual path that comprises the route).

Each of modules of the system 100, including database module 105, situational awareness module 110, communication module 115, 3-D rendering module 120, GUI module 125, model translation model 135, simulation module 140, situational awareness response module 145 and path selection module 150, or any combination thereof, can be comprised of any suitable type of electrical or electronic component or device that is capable of performing the functions associated with the respective element. According to such an exemplary embodiment, each component or device can be in communication with another component or device using any appropriate type of electrical connection that is capable of carrying (e.g., electrical) information. Alternatively, each of the modules of the system 100 can be comprised of any combination of hardware, firmware and software that is capable of performing the functions associated with the respective module.

Alternatively, the system 100 can be comprised of one or more microprocessors and associated memory(ies) that store the steps of a computer program to perform the functions of any or all of the modules of the system 100. The microprocessor can be any suitable type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), an electrically-erasable programmable read-only memory (EEPROM), a computer-readable medium, or the like. The memory can be any suitable type of computer memory or any other type of electronic storage medium, such as, for example, read-only memory (ROM), random access memory (RAM), cache memory, compact disc read-only memory (CDROM), electro-optical memory, magneto-optical memory, or the like. As will be appreciated based on the foregoing description, the memory can be programmed using conventional techniques known to those having ordinary skill in the art of computer programming to perform the functions of any or all of the modules of the system 100. For example, the actual source code or object code of the computer program can be stored in the memory.

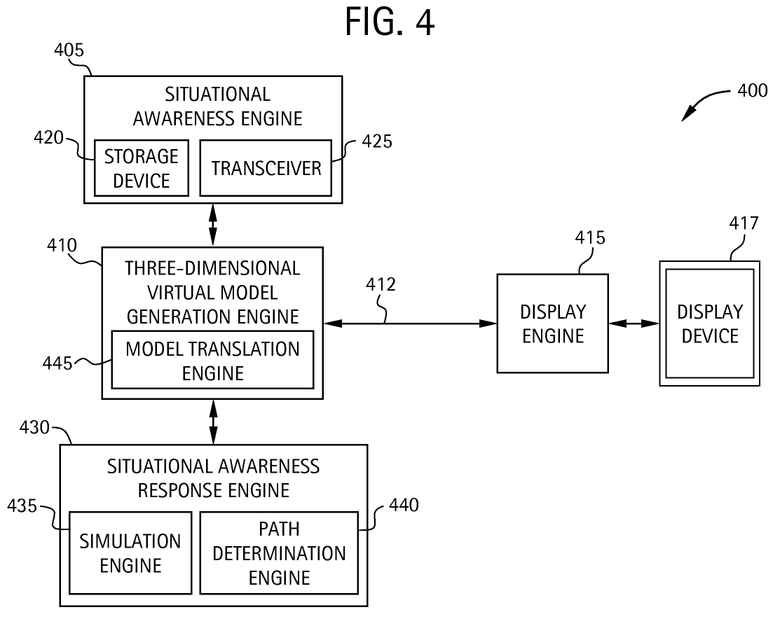

Alternative architectures or structures can be used to implement the various functions of the system 100 as described herein. For example, functions from two or more modules can be implemented in a single module, or functions from one module can be distributed among several different modules. For purposes of illustration and not limitation, FIG. 4 is a block diagram illustrating an emergency response system 400, in accordance with an alternative exemplary embodiment of the present invention. The system 400 includes a situational awareness engine 405. The situational awareness engine 405 is configured to gather situational awareness information associated with a facility. The system 400 includes a 3-D virtual model generation engine 410 in communication with the situational awareness engine 405. The 3-D virtual model generation engine 410 is configured to generate a 3-D virtual model of the facility utilizing structural information associated with the facility. The 3-D virtual model generation engine 410 is configured to incorporate into the 3-D virtual model the situational awareness information associated with the facility. The system 400 also includes a display engine 415 in communication with the 3-D virtual model generation engine 410, for example, via a network connection 412 (e.g., the Internet). The display engine 415 is configured to display the 3-D virtual model of the facility incorporating the situational awareness information associated with the facility to a user for navigating the 3-D virtual model for situation assessment and emergency response planning. For example, a suitable display device 417 in communication with the display engine 415 can be used to display the 3-D virtual model to the user.

The situational awareness engine 405 can include a storage device 420. The storage device 420 can be configured to store the structural information associated with the facility, the situational awareness information associated with the facility, the 3-D virtual model of the facility generated by the 3-D virtual model generation engine 410, and/or any other suitable information. The situational awareness engine 405 can also include or be in communication with a transceiver 425. The transceiver 425 is configured to transmit and receive the situational awareness information.

The system 400 can include a situational awareness response engine 430 in communication with the 3-D virtual model generation engine 410. The situational awareness response engine 430 can be configured to generate one or more proposed response to an emergency or other critical situation occurring within, on or around the facility. The situational awareness response engine 430 can include a simulation engine 435. The simulation engine 435 can be configured to generate simulations of situational awareness scenarios associated with the facility. The situational awareness response engine 430 can also include a path determination engine 440. The path determination engine can be configured to determine ingress and/or egress routes through the facility using the structural information and situational awareness information associated with the facility. The 3-D virtual model generation engine 410 can be configured to render in the 3-D virtual model the ingress and/or egress routes for display to the user. In particular, the path determination engine 440 can be configured to maintain a list of substantially all individual paths through the facility. A route between points in the facility can be comprised of one or more individual paths. Each of the individual paths through the facility can be assigned a path weight in accordance with, for example, the length of the individual path, the level of difficulty in traversing the individual path, and/or other similar factors. The path determination engine 440 can be configured to generate the total path weight of the route by summing the path weights of the individual paths that comprise the route. The 3-D virtual model generation engine 410 can be configured to generate in the 3-D virtual model the route between the points in the facility with the lowest total path weight for display to the user.

The 3-D virtual model generation engine 410 can include a model translation engine 445. The model translation engine can be configured to convert the 3-D virtual model generated by the 3-D virtual model generation engine 410 into a format displayable by the display engine 415. Other such architectures can be used to implement the functions of the systems 100 and 400 according to exemplary embodiments of the present invention.

Those of ordinary skill in the art will recognize that each of the modules of the systems 100 and 400 can be located locally to or remotely from each other, while use of the systems 100 and 400 as a whole still occurs within a given country, such as the United States. For example, merely for purposes of illustration and not limitation, database module 105, situational awareness module 110, communication module 115, 3-D rendering module 120, model translation model 135, simulation module 140, situational awareness response module 145 and path selection module 150 (or any combination of such modules) can be located extraterritorially to the United States (e.g., in Canada and/or in one or more other foreign countries), while the GUI module 125 can be located within the United States, such that the control of the system 100 as a whole is exercised and beneficial use of the system 100 is obtained by the user within the United States.

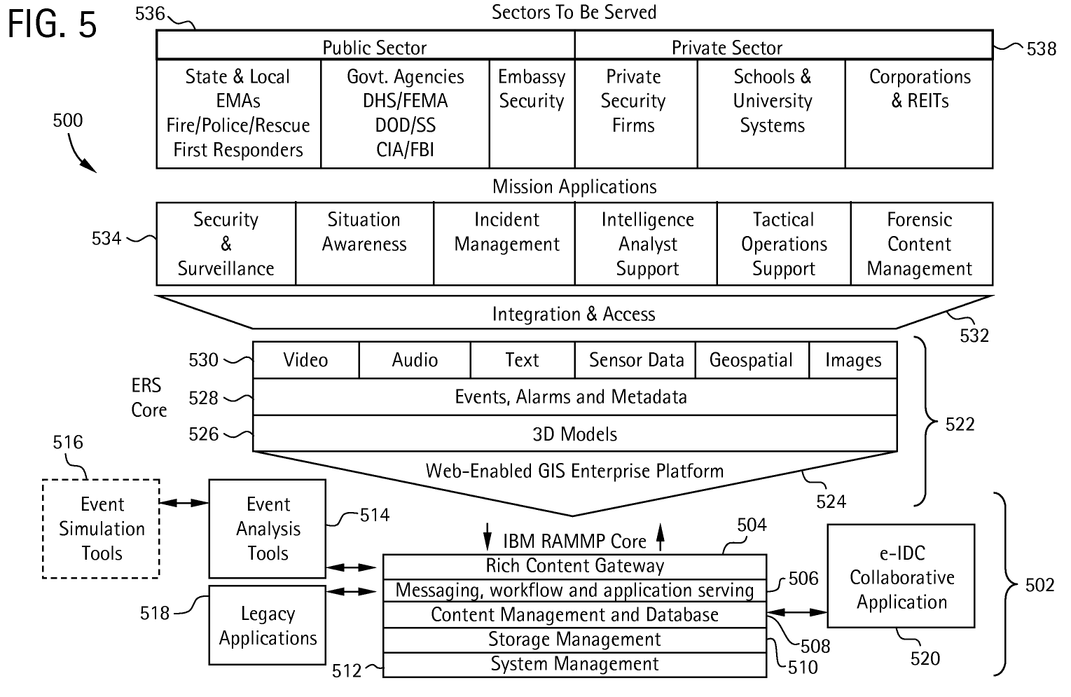

As discussed previously, exemplary embodiments of the present invention, particularly the functionality of systems 100 and 400 illustrated in FIGS. 1 and 4, respectively, can be implemented using any suitable hardware/software/firmware architecture. For purposes of illustration and not limitation, FIG. 5 is a schematic illustrating an application layer diagram 500 for the Emergency Response System, in accordance with an exemplary embodiment of the present invention. A first application layer 502 can include such application functionality as a rich content gateway application 504, a messaging/workflow/application server 506, a content management and database application 508, a storage management application 510, and a systems management application 512. Such application functionality in the first application layer 502 can be used to implement some or all of the functionality of, for example, the database module 105, the situational awareness module 110 and the communication module 115 illustrated in FIG. 1. The rich content gateway application 504 can be in communication with event analysis tools 514. The event analysis tools 514 can be used to implement some or all of the functionality of, for example, the situational awareness response module 145 and the path selection module 145. The event analysis tools 514 can be in communication with the event simulation tools 516 that can be used to implement some or all of the functionality of, for example, the simulation module 140. The messaging/workflow/application server 506 can be in communication with appropriate legacy applications 518, such as legacy crisis incident management and integrated incident management systems to facilitate collaboration between those systems and the Emergency Response System. Such collaboration can be enhanced using appropriate collaborative applications 520 in communication with the content management and database application 508.

According to an exemplary embodiment of the present invention, some or all of the applications that comprise the first application layer 502 can be implemented using, for example, the Real-time, Adaptive, Multi-Intelligence, Multimedia Platform (RAMMP) offered by International Business Machines, Inc. (White Plains, N.Y.). IBM's RAMMP provides a digital media platform for digital content management and dissemination and collaboration, and offers high-speed ingestion and analysis of video, audio and multi-sensor data in multiple formats and types. The RAMMP enables users to manage and distribute video and other graphical information at variable bandwidths, resolutions and formats. In addition, the RAMMP supports real-time, proactive response to dynamic situations and persistent monitoring. However, skilled artisans will recognize that other software applications, platforms or techniques can be used to implement the first application layer 502 illustrated in FIG. 5 according to exemplary embodiments.

A second application layer 522 can include such application functionality as a Web-enabled GIS enterprise platform application 524, a 3-D model application 526, an event/alarm/metadata application 528, and a sensor data collection application 530 for collecting such sensor data as video, audio, text, geospatial, image and other sensor data. Such application functionality in the second application layer 522 can be used to implement some or all of the functionality of, for example, situational awareness module 110, 3-D rendering module 120, model translation module 135 and GUI module 125.

Additionally, an integration and access application layer 532 can provide the functionality (e.g., communication interfaces, data format conversion and the like) for interfacing the Emergency Response System to various mission applications 534 and any systems (e.g., legacy applications) supported by the mission applications 534. According to exemplary embodiments, the Emergency Response System can be configured to support mission applications 534 including, but not limited to, security and surveillance, situational awareness, incident management, intelligence analyst support, tactical operations support, forensic content management and any other suitable mission application. The ERS can be configured to serve the public sector 536, for example, state and local EMAs, fire, police, rescue, first responders, government agencies, such as DHS, FEMA, DOD, SS, CIA, FBI and the like, embassy security and other entities in the public sector 536. Additionally or alternatively, the ERS can be configured to serve the private sector 538, such as private security firms, schools and university systems, corporations and REITs, and other entities in the private sector 538.

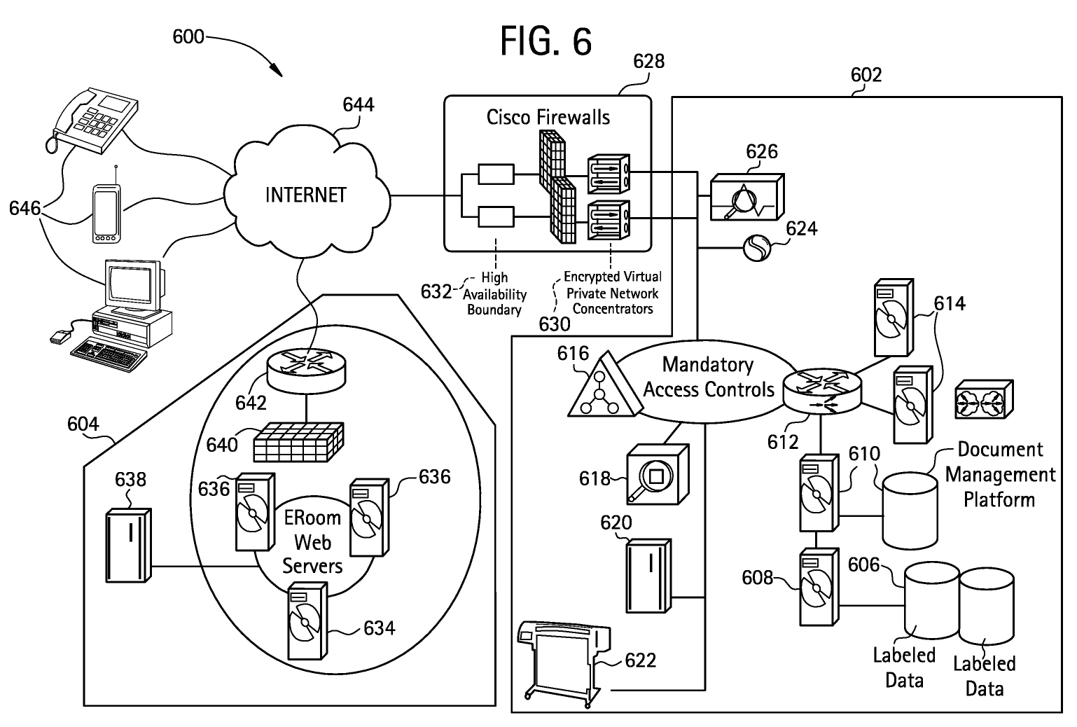

For purposes of illustration and not limitation, FIG. 6 is a schematic illustrating an example of a hardware/software architecture 600 of the Emergency Response System, in accordance with an exemplary embodiment of the present invention. The hardware architecture 600 can include a first subsystem 602 and a second subsystem 604. The first subsystem 602 can include database files 606 in communication with a suitable NAS/SAN solution 608 (e.g., such as the EMC² NAS/SAN Solution offered by EMC Software) that can be in communication with a suitable database server 610 (e.g., the Documentum 5 Platform for document management offered by EMC Software). The database server 610 can be in communication with a content router 612. Web servers 614 can also be in communication with content router 612. Mandatory access controls can be provided by role-based access controls 616 that is communication with the content router 612. A network manager server 618 can be in communication with the role-based access controls 616. In addition, a tape backup and restore store 620 and a print-on-demand solution 622 can also be in communication with the role-based access controls 616. To prevent malicious attacks or other unwanted or unauthorized intrusions into the first subsystem 602, an anti-virus application 624 (e.g., offered by Symantec Corporation of Cupertino, Calif.) and an intrusion detection and encryption solution 626 (e.g., those offered by The Windermere Group, LLC of Annapolis, Md.) can be used. For example, the first subsystem 602 can be used to implement any or all of the functionality of the database module 105, situational awareness module 110, communication module 115, 3-D rendering module 120, GUI module 125, model translation module 135, simulation module 140, situational awareness response module 145 and path selection module 150. The first subsystem 602 can be located behind suitable firewalls 628 (e.g., those offered by Cisco Systems, Inc. of San Jose, Calif.) that can include appropriate encrypted virtual private network concentrators 630 and a high-availability boundary 632.

The second subsystem 602 can include a database server 634 in communication with one or more Web servers 636 and a tape backup and restore solution 638. The database server 634 and Web servers 636 can be located behind a suitable firewall 640, such as, for example, a Cisco Pix 515E Firewall or the like offered by Cisco Systems, Inc. (San Jose, Calif.). The firewall 640 can be in communication with an appropriate router 642, such as, for example, a Cisco 1700 Router or the like offered by Cisco Systems, Inc. For example, the second subsystem 604 can be used to implement any or all of the functionality of the database module 105, situational awareness module 110, communication module 115, 3-D rendering module 120, GUI module 125, model translation module 135, simulation module 140, situational awareness response module 145 and path selection module 150. For example, the functionality of the system 100 (or the system 400) can be distributed across the first and second subsystems 602 and 604 to implement the features of the Emergency Response System according to exemplary embodiments.

The first and second subsystems 602 and 604 can be in communication via any suitable form of network, such as an intranet or an internet, for example, the Internet 644. The functionality and features of the Emergency Response System that can be implemented in the first and second subsystems 602 and 604 can be accessed via a connection over the Internet 644 using suitable graphical user interfaces running on display devices 646. To ensure encryption of data and maintenance of the security of the system 600, the display devices 646 can access the first and second subsystems 602 and 604 via an encrypted virtual private network (VPN), such as, for example, using the BorderGuard Series of Secure Communication Platforms offered by Blue Ridge Networks, Inc. (Chantilly, Va.) for encrypted VPN for session confidentiality. In addition, role-based access controls and authentication with user certificates, as well as other encryption and security features (e.g., secure socket layer (SSL) for transmitting information via the Internet 644) can be used to ensure a high level of security and encryption of data communicated through the network. However, skilled artisans will recognize that other hardware/software architectures can be used to implement the features of the Emergency Response System according to exemplary embodiments.

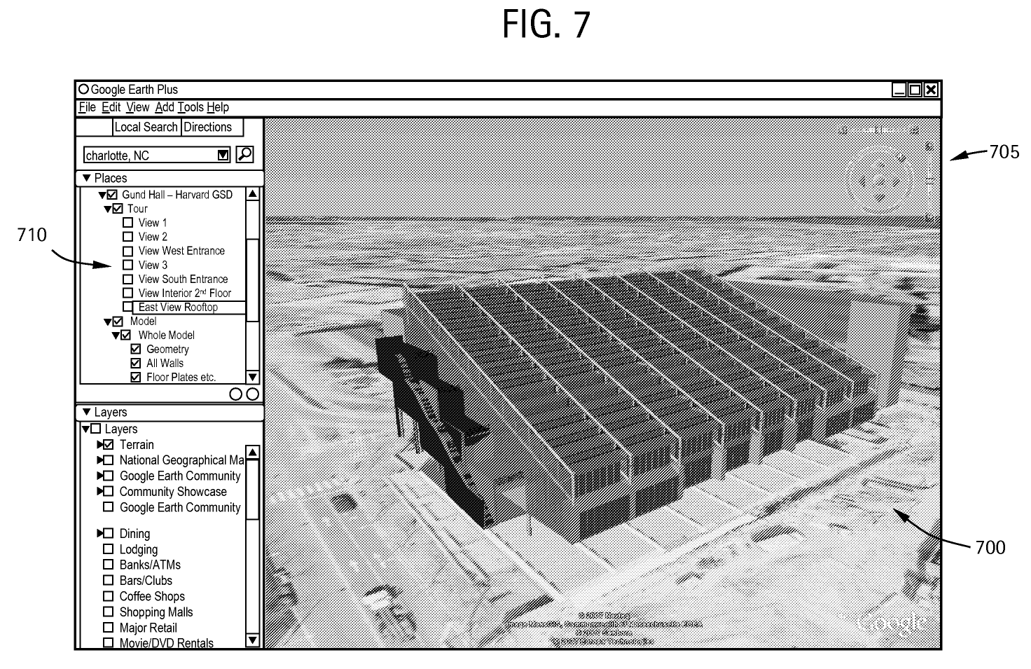

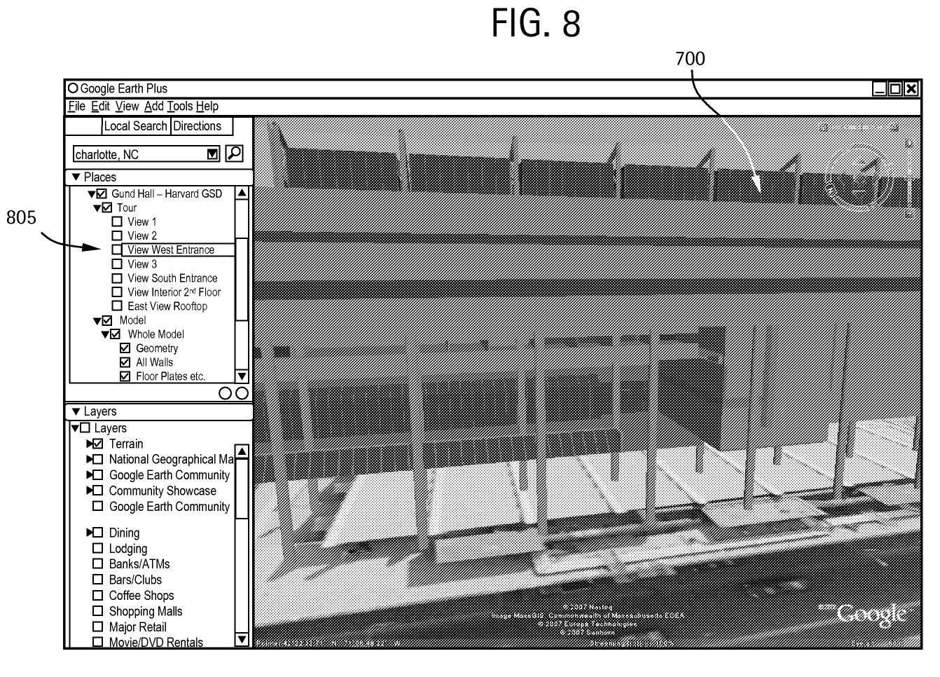

For purposes of illustration and not limitation, FIG. 7 is first diagram illustrating a 3-D virtual model 700 of a structure that was created with REVIT™ Building and being displayed in GOOGLE™ Earth, in accordance with an exemplary embodiment of the present invention. The 3-D virtual model 700 is of Gund Hall that houses the Graduate School of Design at Harvard University in Cambridge, Mass. The 3-D virtual model 700 was created according to exemplary embodiments of the present invention using, for example, structural information associated with the structure. The first diagram illustrated in FIG. 7 is an exterior view of Gund Hall from the southeast corner of the building. Navigation controls 705 are presented to the user for manually changing the view aspect of the 3-D virtual model, including moving the model up/down and left/right, zooming the model in/out, rotating the model up/down and left/right, changing elevation and the other like controls. In addition, view controls 710 can be used as “shortcuts” to change the view of the 3-D virtual model to a predetermined angle, rotation, elevation and the like. For example, FIG. 8 is a second diagram illustrating the 3-D virtual model 700 from the west entrance of Gund Hall, in accordance with an exemplary embodiment of the present invention. By selecting the view control 805 for “View West Entrance,” GOOGLE™ Earth can automatically adjust the viewing aspect to present the predetermined view of the 3-D virtual model 700 to the user.

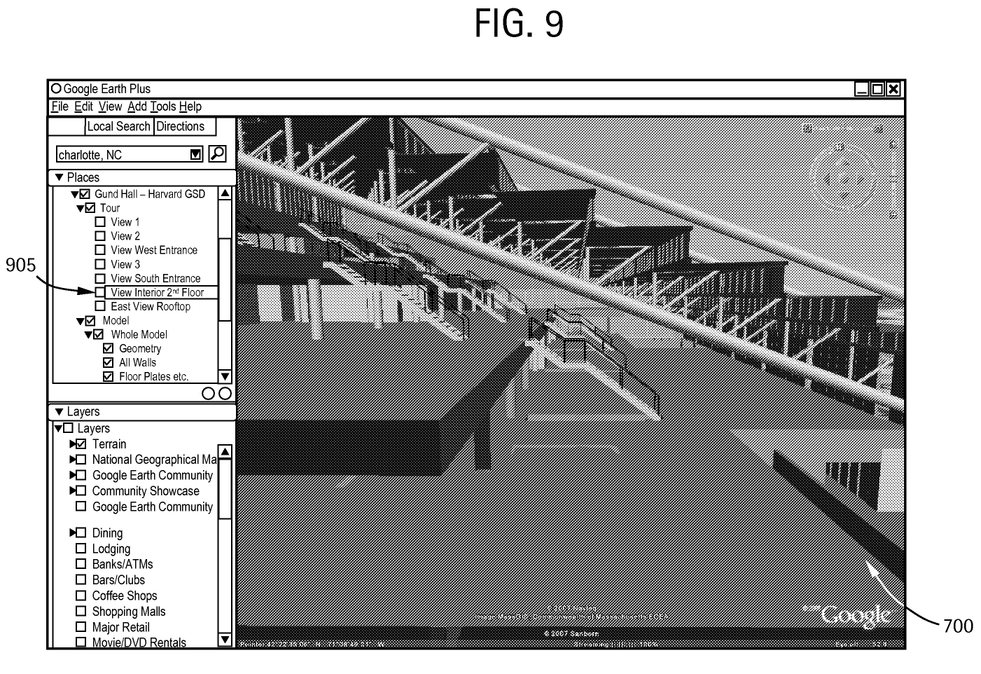

The user can view any aspect or portion, whether interior or exterior, of the 3-D virtual model 700 using the appropriate navigation controls. For example, FIG. 9 is a third diagram illustrating the 3-D virtual model 700 from the interior of Gund Hall, in accordance with an exemplary embodiment of the present invention. In particular, FIG. 9 illustrates the interior second floor of Gund Hall, showing such features as stairs, rails, floors, ceiling beams or trusses, and the like. The user can manually “enter” the interior of the 3-D virtual model 700 by using the appropriate navigation controls. Alternatively, a view control 905 for “View Interior 2nd Floor” can cause GOOGLE™ Earth to automatically adjust the view to present the predetermined interior view of the 3-D virtual model 700 to the user.

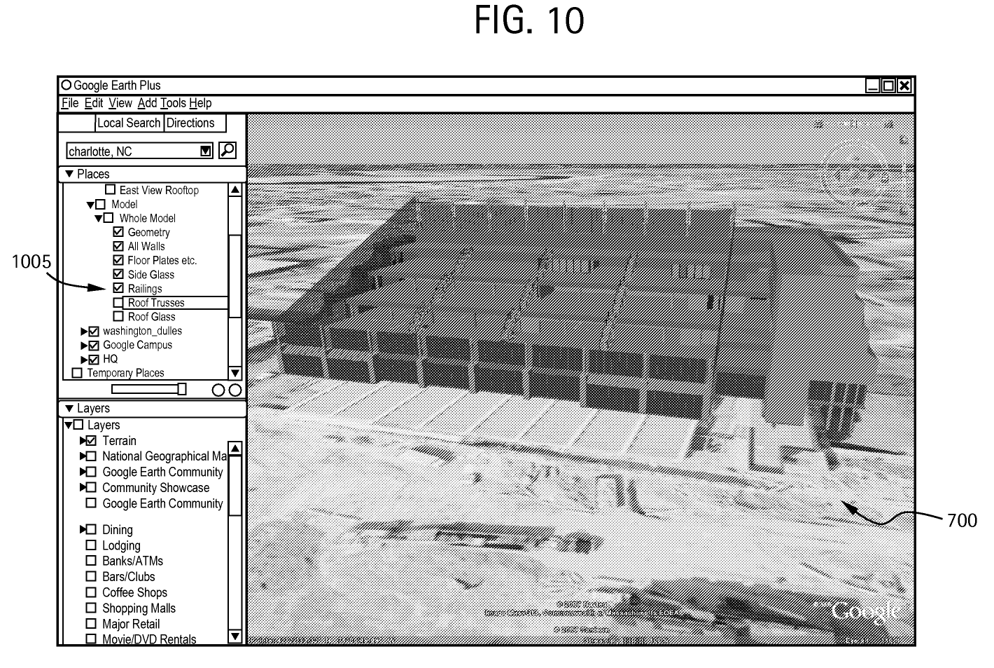

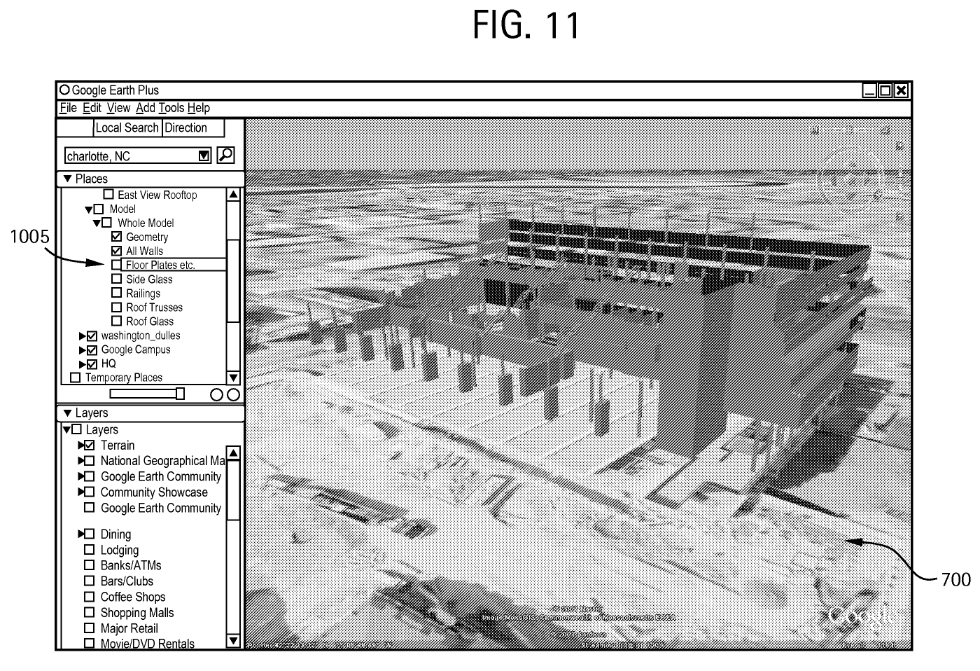

As discussed previously, the Emergency Response System can allow the user to “peel away” the outer layers of the 3-D virtual model 700 to view successively more interior views of the structure. For example, FIG. 10 is a fourth diagram illustrating the 3-D virtual model 700 with several layers of Gund Hall removed, in accordance with an exemplary embodiment of the present invention. Appropriate layer controls 1005 can be used to remove and restore various layers or other features of the 3-D virtual model 700 to allow the user to view any interior or exterior feature, such as structural elements and the like. For example, the layer controls 1005 can allow the user to remove and restore such features as “All Walls,” “Floor Planes,” “Side Glass,” “Railings,” “Roof Trusses,” and “Roof Glass,” among other features of the 3-D virtual model 700. In FIG. 10, the layer controls 1005 have been used to remove or otherwise peel away the “Roof Trusses” and the “Roof Glass” to provide an interior view of Gund Hall. Any level of interior or exterior detail of the structure can be viewed in such a manner. For example, FIG. 11 is a fifth diagram illustrating the 3-D virtual model 700 with several additional layers of Gund Hall removed, in accordance with an exemplary embodiment of the present invention. In FIG. 11, the layer controls 1005 have been used to remove or otherwise peel away the “Floor Planes,” “Side Glass,” “Railings,” “Roof Trusses,” and “Roof Glass” of the 3-D virtual model 700 to reveal only the interior and exterior walls of Gund Hall.

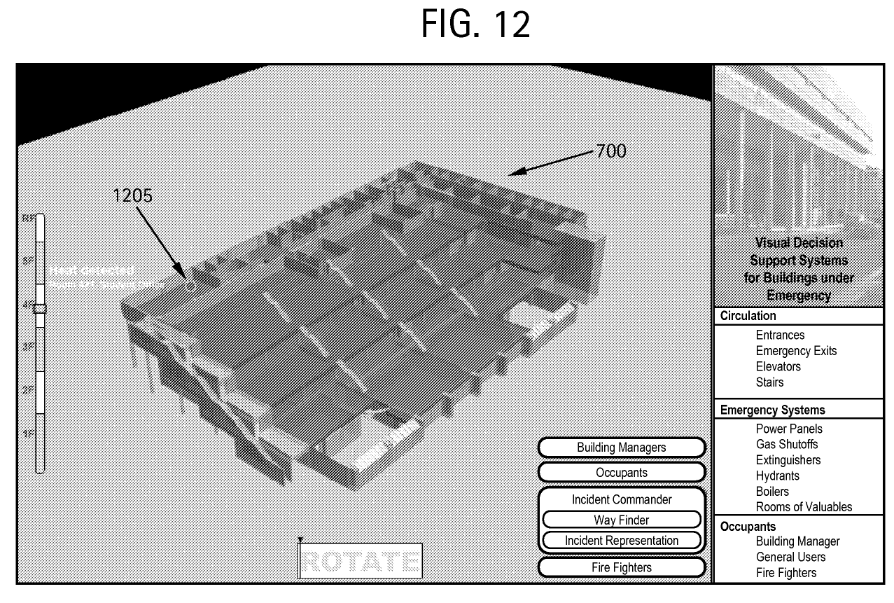

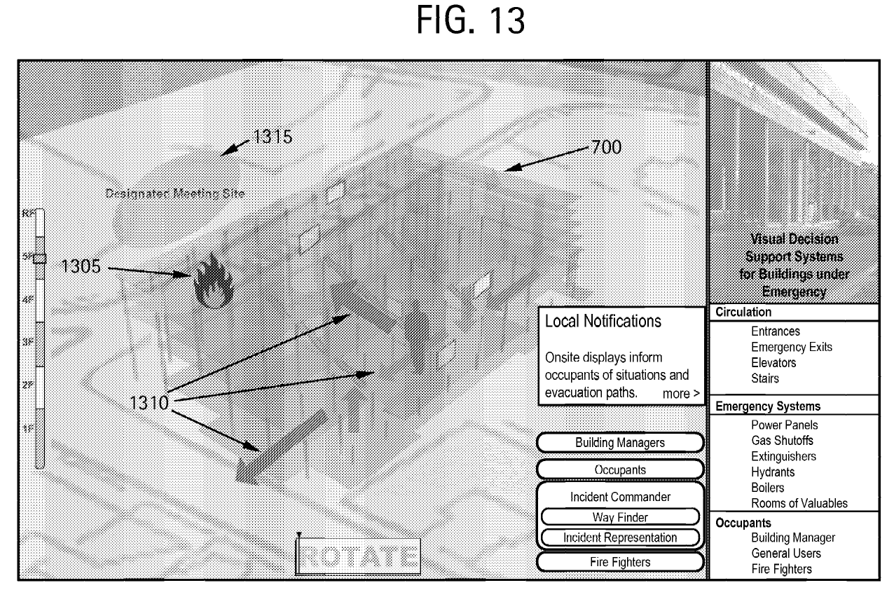

According to exemplary embodiments, real-time or near real-time situational awareness information can be integrated into the 3-D virtual model for purposes of situational assessment and response planning. For example, FIG. 12 is a sixth diagram illustrating the 3-D virtual model 700 integrating situational awareness information, in accordance with an exemplary embodiment of the present invention. As illustrated in FIG. 12, the 3-D virtual model 700 incorporates (real-time or near real-time) sensor data from a heat sensor and displays such information as a dot 1205 to indicate both that heat has been detected and the particular room in Gund Hall in which the sensor is located (e.g., Room 421, Student Office). Based on such information, appropriate situation assessment and response planning can be undertaken. According to exemplary embodiments, the Emergency Response System can provide one or more proposed responses based on the situational awareness information. For example, FIG. 13 is a seventh diagram illustrating the 3-D virtual model 700 providing proposed responses based on the situational awareness information, in accordance with an exemplary embodiment of the present invention. As illustrated in FIG. 13, the Emergency Response System has determined that the situational awareness information from the heat sensor indicates that a fire is occurring in the given room, and can display a flame or fire icon 1305 to illustrate the danger. In response, the Emergency Response System can display evacuation routes 1310 from the structure and the predetermined designated meeting site 1315 for the evacuees to ensure that everyone has safely left the structure.

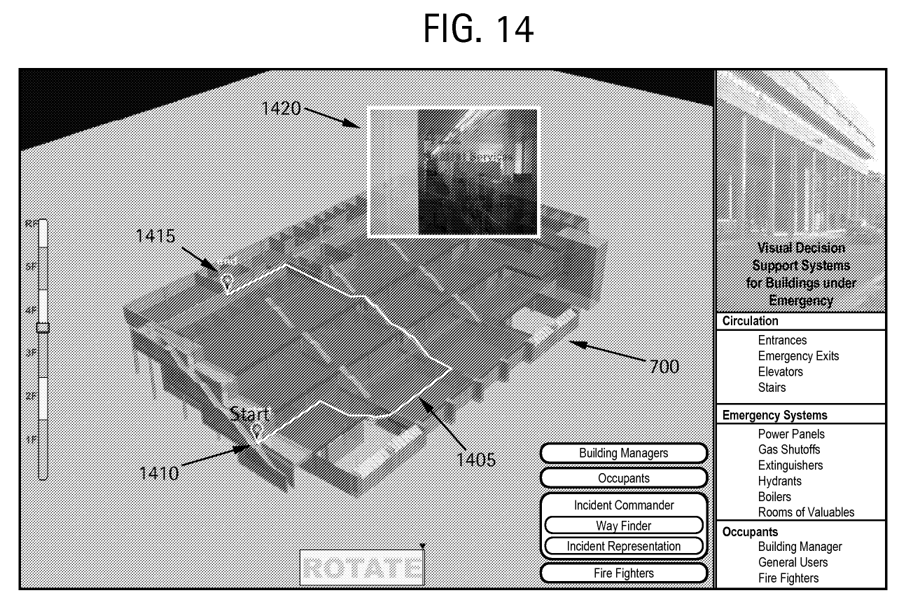

As discussed previously, the Emergency Response System can provide a display of ingress and/or egress routes or other paths through the structure. For example, FIG. 14 is an eighth diagram illustrating the 3-D virtual model 700 providing a route 1405 through the structure based on the situational awareness information, in accordance with an exemplary embodiment of the present invention. As illustrated in FIG. 14, the route 1405 is indicated by a line of conjoined individual paths through the structure. The contiguous route 1405 begins at a starting point 1410 located at a side entrance to Gund Hall. Based on the available situational awareness information (e.g., no internal impediments, barriers or blockades detected), the Emergency Response System can provide the shortest route 1405 to the center of the disturbance (i.e., the end point 1415 where the heat sensor has been activated). According to an exemplary embodiment, a video 1420 of the route 1405 can be displayed to the user, visually taking the user through the entire route 1405 from starting point 1410 to end point 1415, e.g., as a streaming video or a series of still pictures of the interior of the structure along the route 1405. For example, such a video 1420 can allow the user to determine if there are any additional dangers or other critical situations posed to emergency personnel traversing the route 1405, as well as for providing visual directions or cues to reach the end point 1415.

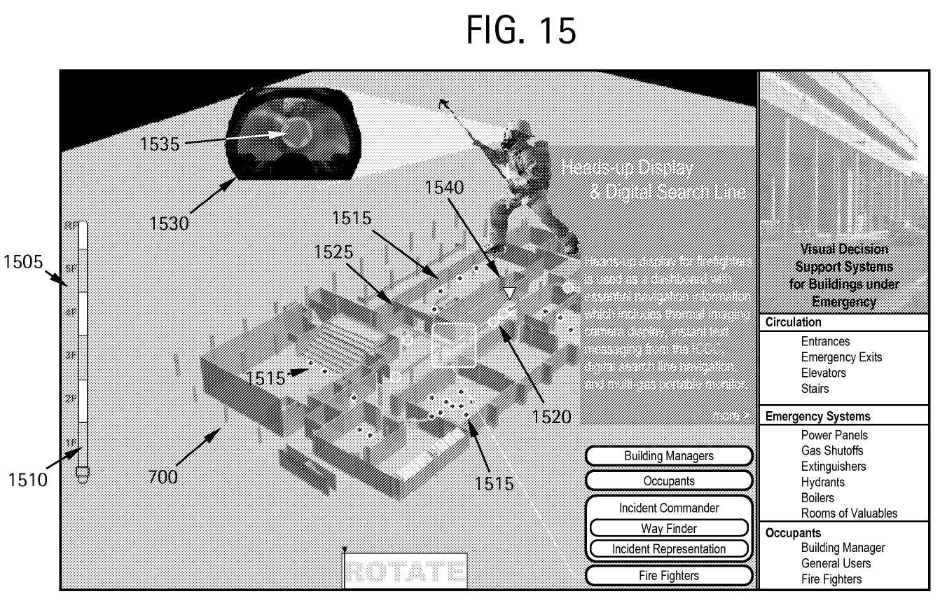

FIG. 15 is an ninth diagram illustrating the 3-D virtual model 700 integrating additional situational awareness information, in accordance with an exemplary embodiment of the present invention. As noted previously, the user can “peel away” layers of the 3-D virtual model 700 to view any interior aspect of the structure. For example, a sliding bar 1505 can be used to peel away any upper floors of the structure in the 3-D virtual model 700 by moving the layer marker 1510 to the desired floor indication (e.g.,“1F” for first floor, “2F” for second floor, “3F” for third floor, “4F” for fourth floor, “5F” for fifth floor, and “RF” for roof). In FIG. 15, the layer marker 1510 has been moved to “1F” (i.e., the first floor), thereby peeling away the second through fifth floors and roof to reveal the first floor of Gund Hall. The situational awareness information associated with the first floor is thus displayed to the user. Such situational awareness information can include locations of people (indicated by small dots 1515) and emergency response personnel (indicated by large dots 1520) on the first floor, as well as the search line (indicated by line 1525) being undertaken by the emergency response personnel. Any portion or all of the 3-D virtual model 700 and the integrated situational awareness information can also be displayed to the emergency response personnel in a suitable heads-up display 1530 located in their helmets. Such a heads-up display 1530 can provide an arrow 1535 or other direction indicator to direct the emergency response personnel to a desired location within the structure indicated by a location marker 1540.

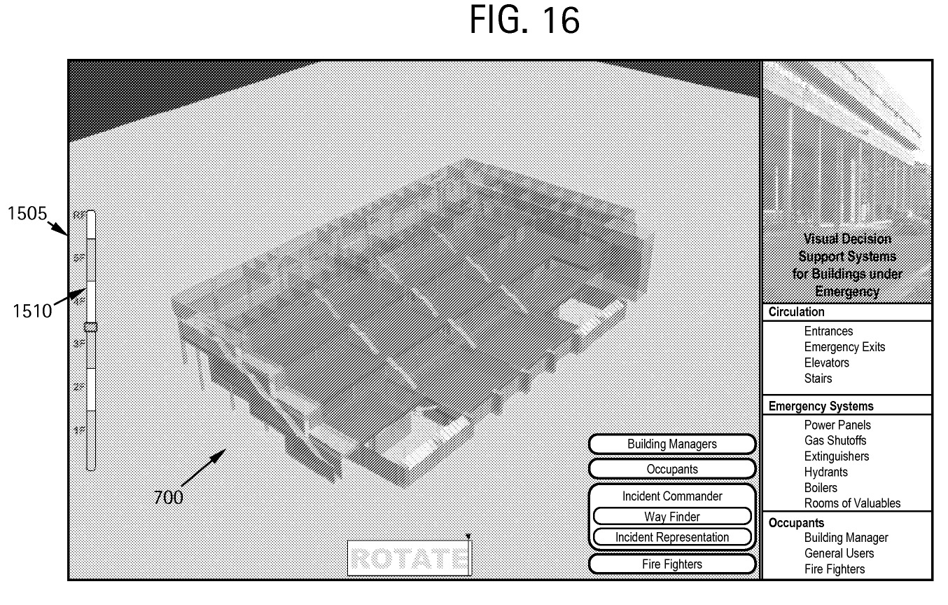

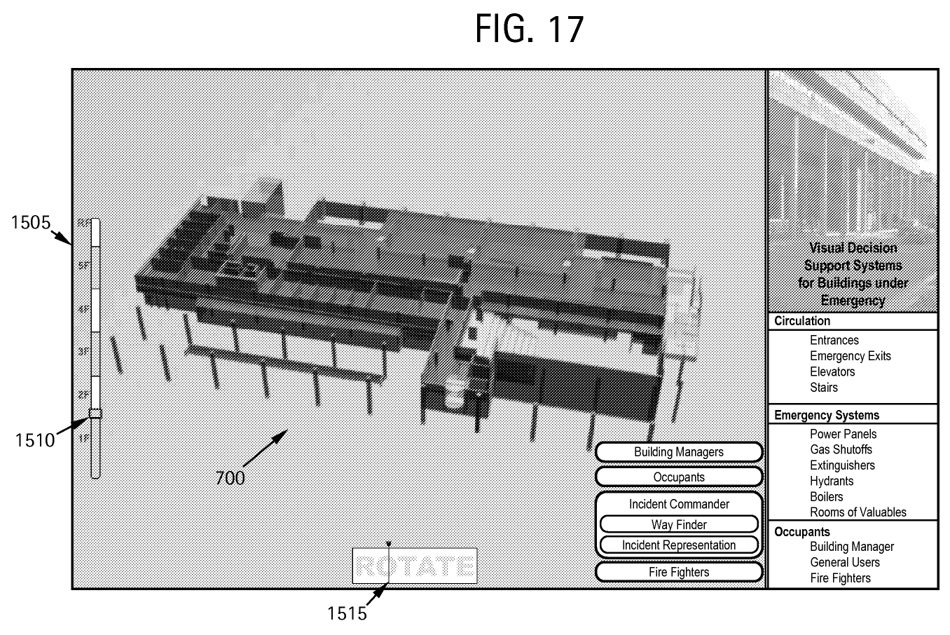

Using the sliding bar 1505, any floor or floors (and any features on those floors) of the structure can be viewed in the 3-D virtual model 700 by moving the layer marker 1510 to the desired floor indication. For example, FIG. 16 is a tenth diagram illustrating the 3-D virtual model 700 with several floors peeled away, in accordance with an exemplary embodiment of the present invention. In FIG. 16, the layer marker 1510 has been moved to “4F” (i.e., the fourth floor), thereby peeling away the fifth floor and roof to reveal the fourth floor of Gund Hall. In addition, once peeled away, the view of the 3-D virtual model 700 can be altered. For example, FIG. 17 is an eleventh diagram illustrating the 3-D virtual model 700 rotated and with several floors peeled away, in accordance with an exemplary embodiment of the present invention. In FIG. 17, the layer marker 1510 has been moved to “1F” (i.e., the first floor), thereby peeling away the second through fifth floors and roof to reveal the first floor of Gund Hall. In addition, a rotational control 1515 can be moved to rotate the 3-D virtual model 700, for example, to review the opposing side of the first floor of Gund Hall.

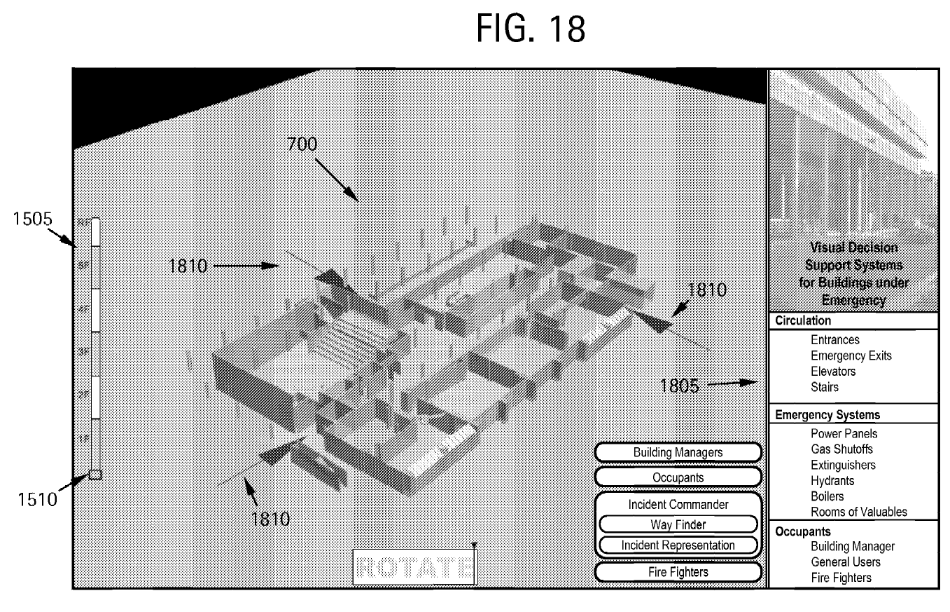

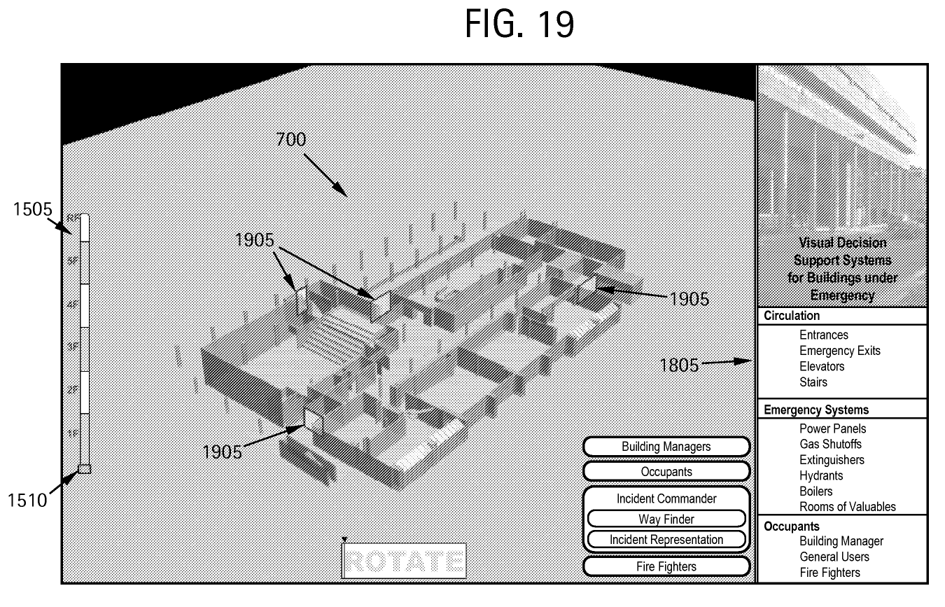

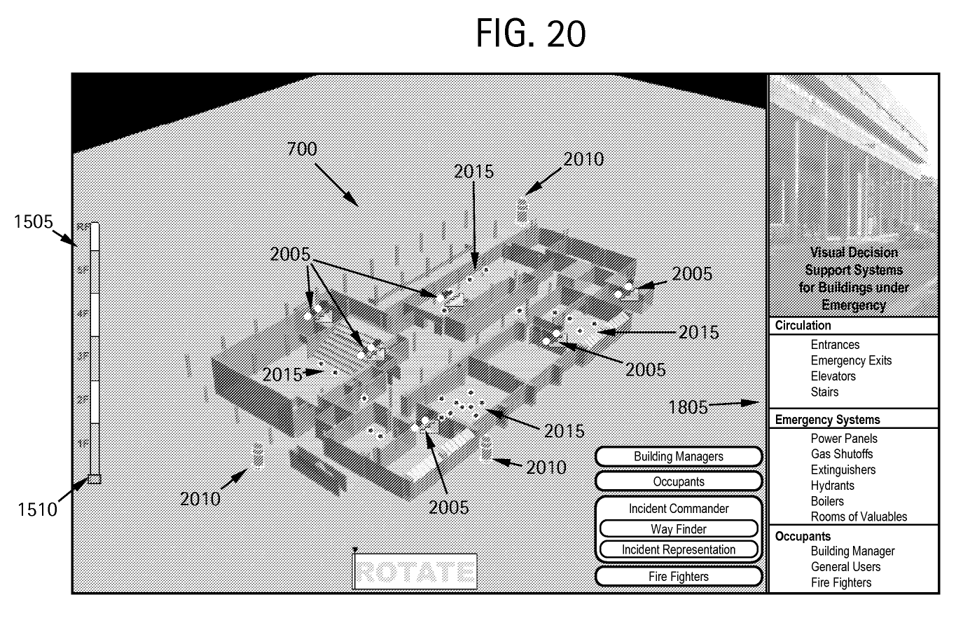

In addition, any features of or on a floor of the structure can be displayed to the user. For example, FIG. 18 is an twelfth diagram illustrating the 3-D virtual model 700 with several floors peeled away and indicating various features located on the displayed floor, in accordance with an exemplary embodiment of the present invention. In FIG. 18, the layer marker 1510 still indicates “1F” (i.e., the first floor), thereby peeling away the second through fifth floors and roof to reveal the first floor of Gund Hall. Feature display controls 1805 can be used to indicate the types and locations of various types of equipment and other structural elements in the given view. For example, by selecting “Entrances” from the feature display controls 1805, the location of entrances to the structure on the first floor can be displayed to the user (e.g., as arrows 1810). FIG. 19 is a thirteenth diagram illustrating the 3-D virtual model 700 with several floors peeled away and indicating additional features located on the displayed floor, in accordance with an exemplary embodiment of the present invention. In FIG. 19, by selecting “Emergency Exits” from the feature display controls 1805, the location of emergency exits in the structure on the first floor can be displayed to the user (e.g., as rectangles 1905). FIG. 20 is a fourteenth diagram illustrating the 3-D virtual model 700 with several floors peeled away and indicating additional features located on the displayed floor, in accordance with an exemplary embodiment of the present invention. In FIG. 20, by selecting “Stairs,” “Hydrants,” and “Occupants” from the feature display controls 1805, the location of stairs (e.g., indicated with stair icons 2005), hydrants (e.g., indicated as hydrant icons 2010) and occupants (e.g., indicated as dots 2015) can be displayed to the user. Thus, according to exemplary embodiments, by integrating real-time or near real-time situational awareness information into the 3-D virtual model 700 of the structure, the user can view a complete, up-to-date perspective of the interior and exterior of the structure to allow for proper situational assessment and response planning for any emergency or other critical situation occurring in, on, within or around the structure.

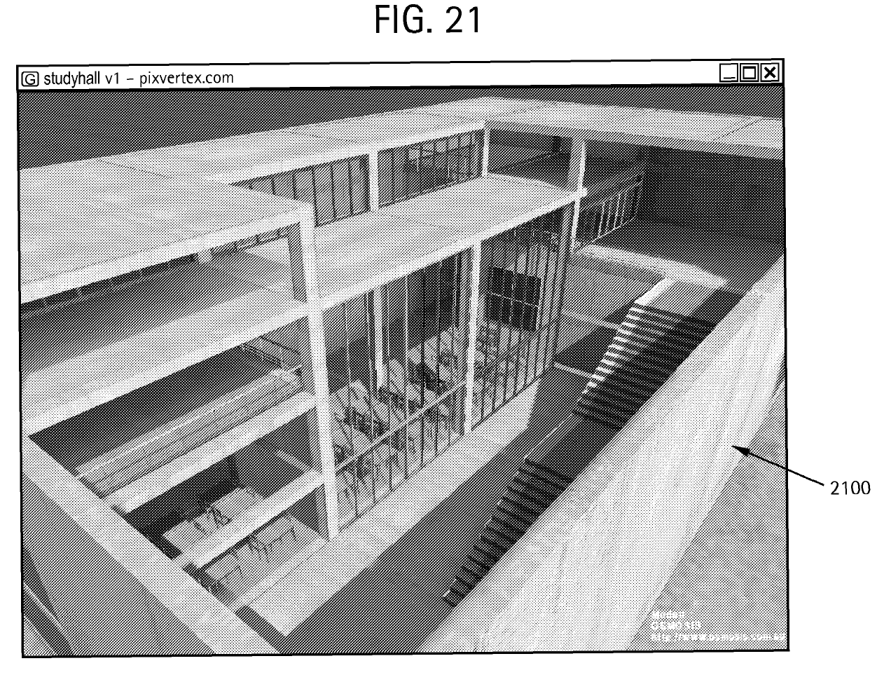

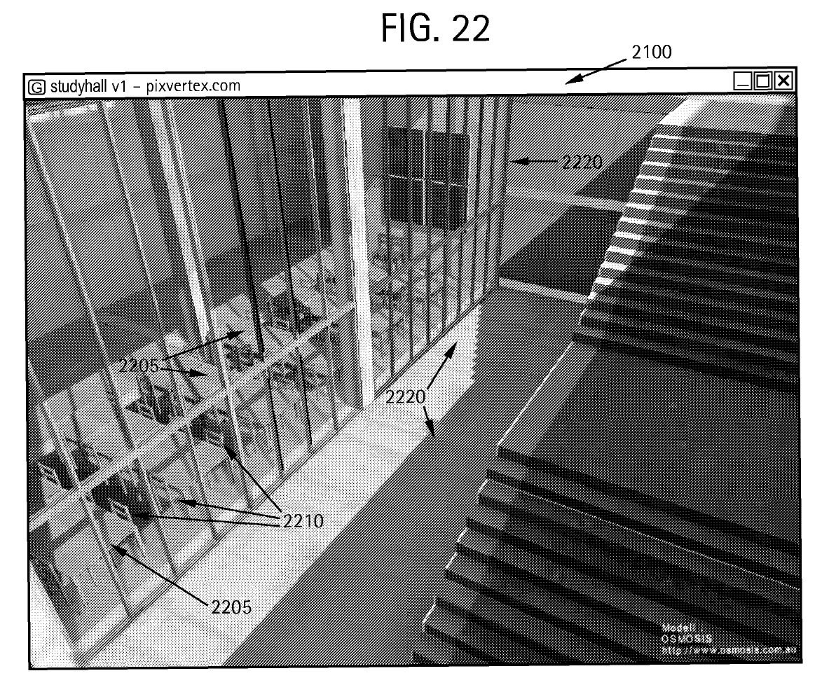

The 3-D virtual model of the structure can be displayed to the user in any desired detail. For example, the 3-D virtual model can comprise a photo-realistic representation of the structure. FIG. 21 is a diagram illustrating a 3-D virtual model 2100 as a photo-realistic representation of the structure, in accordance with an exemplary embodiment of the present invention. The 3-D virtual model 2100 illustrated in FIG. 21 is a photo-realistic representation of a study hall, e.g., at a university, looking down into the study hall from above. As can be seen, such a 3-D virtual model 2100 provides much greater detail of the structure, including texture of surfaces, representation of furniture in rooms, and the like. For example, FIG. 22 is a diagram illustrating a magnified or zoomed-in view of the 3-D virtual model 2100, in accordance with an exemplary embodiment of the present invention. As can be seen in FIG. 22, the photo-realistic representation of the structure provides a view of furniture within the study hall, such as tables 2205 and chairs 2210, looking through the windows 2215 of the structure, as well as appropriate shading 2220 to provide simulated depth to the 3-D virtual model 2100. Being a virtual model, such a photo-realistic representation of the structure can be used to, for example, peer through or around walls or obstacles to provide the user with a visualization of any potential threats that may not be visible to a person actually standing in the structure. In such a way, emergency response personnel can be provided with an accurate tactical assessment within the structure, such as the locations of terrorists or other hostiles located in the structure that may not be easily visible to such personnel. Those of ordinary skill in the art will recognize that other such uses can be made of the Emergency Response System with the 3-D virtual model of the structure integrating the situational awareness information.

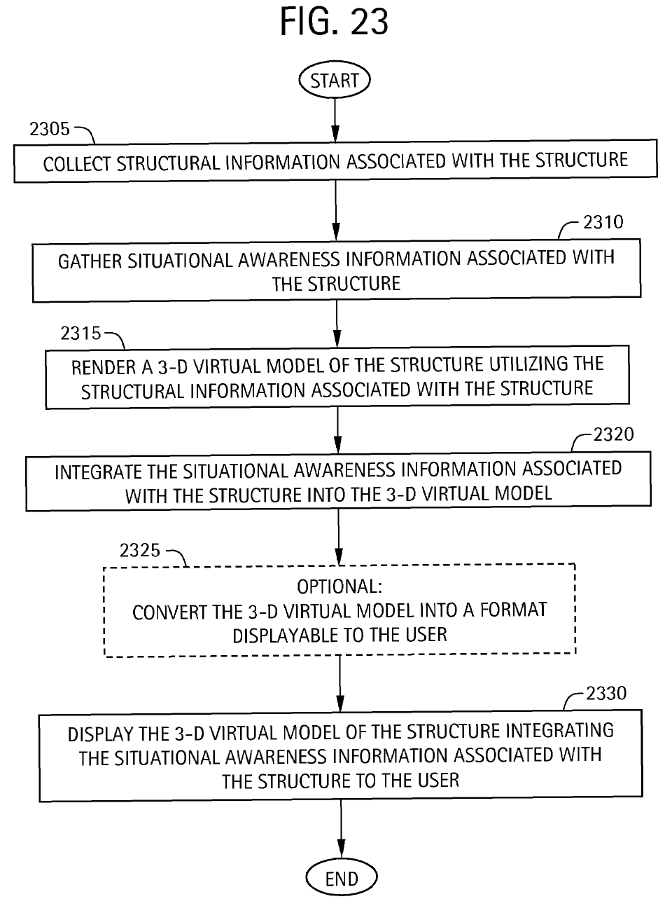

FIG. 23 is a flowchart illustrating steps for providing situational awareness for a structure, in accordance with an exemplary embodiment of the present invention. In step 2305, structural information associated with the structure can be collected. In step 2310, situational awareness information associated with the structure can be gathered. For purposes of illustration and not limitation, the situational awareness information can include, for example, sensor data received from sensors associated with the structure. For example, the sensors can include smoke sensors, infrared sensors, video surveillance cameras, motion sensors or any other suitable type of sensor that can be used to provide information on the structure. Additionally, the situational awareness information can include information associated with an emergency occurring within the structure. The situational awareness information can also include alert or alarm notifications associated with the structure. In addition, the situational awareness information can include environmental information associated with the structure, such as that obtained from external sources or data feeds, as discussed previously. The sensor data can comprise real-time or near-real-time sensor data, as well as historical sensor data. For example, the situational awareness information can be transmitted and received in real-time or substantially real-time. Additionally, the situational awareness information can be communicated for collaborative situation assessment and response planning. For example, the situational awareness information can be communicated with crisis incident management systems, integrated incident management systems, and other like systems.

In step 2315, a 3-D virtual model of the structure can be rendered utilizing the structural information associated with the structure. For example, the structural information used to render the 3-D virtual model can include attributes of objects associated with the structure. Accordingly, the attributes of each object can be displayed to the user upon request. For example, callouts can be displayed to the user for presenting the attributes of each object within the structure. According to an exemplary embodiment, the 3-D virtual model can comprise a parametric 3-D virtual model. Thus, a modification to at least one attribute of a first object can be received, and attributes of at least a second object associated with the first object can be modified within the parametric 3-D virtual model. Additionally or alternatively, the objects can comprise smart objects. Accordingly, an impact or effect of an action directed to a smart object can be rendered using the attributes of the smart object and the nature of the action for display to the user.

In step 2320, the situational awareness information associated with the structure can be integrated or otherwise rendered into the 3-D virtual model. For example, the sensor data can be rendered into the 3-D virtual model for display to the user. According to an exemplary embodiment, at least one sensor rendered within the 3-D virtual model can comprise a linking point. Consequently, the sensor data received from the sensor can be displayed to the user upon user selection of a corresponding linking point. For example, the environmental information can be rendered in the 3-D virtual model for displaying to the user the environment in which the structure resides. Additionally or alternatively, locations of objects within the structure (e.g., physical assets or components or the structure, people and other like objects) can be rendered in the 3-D virtual model for display to the user. For example, simulations of situational awareness scenarios associated with the structure can be generated and rendered into the 3-D virtual model for display to the user. Additionally or alternatively, at least one proposed response to an emergency situation occurring within the structure can be generated and rendered into the 3-D virtual model for display to the user.

Optionally, in step 2325, the 3-D virtual model can be converted into a format displayable to the user. In step 2330, the 3-D virtual model of the structure integrating the situational awareness information associated with the structure can be displayed to the user. For example, layers of the 3-D virtual model can be displayed to the user for viewing structural elements and/or internal layouts of the structure. The structural elements can include, but are not limited to, plumbing systems, electrical systems, mechanical systems, environmental systems, emergency equipment systems of the structure or any other suitable structural elements of the structure or any combination thereof. To view any and all aspects of the 3-D virtual model, instructions can be received from the user for navigating the 3-D virtual model to examine the structure and the situational awareness information associated with the structure. The situational awareness information associated with the structure, the 3-D virtual model of the structure integrating the situational awareness information, and any other suitable information associated with the 3-D virtual model (e.g., the structural information associated with the structure) can be stored for back-up and archival purposes.

According to exemplary embodiments, the 3-D virtual model of the structure integrating the situational awareness information associated with the structure can be displayed to the user through a Web browser, such as on any suitable (substantially) fixed or portable display device. For example, the 3-D virtual model of the structure and associated information can be displayed on such display devices using a suitable GIS, and can be displayed locally or remotely, such as over a network (e.g., an intranet or an internet, such as the Internet or World Wide Web).

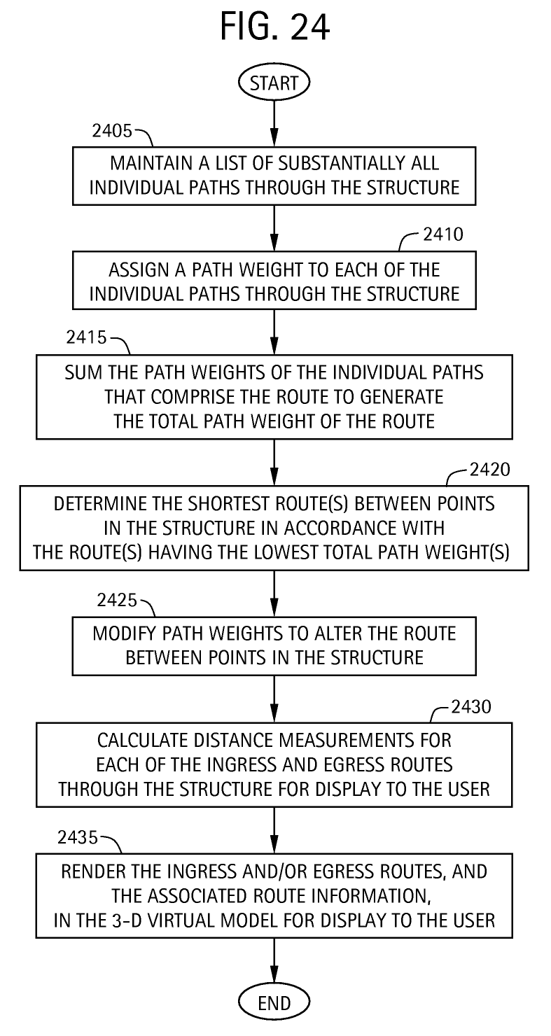

FIG. 24 is a flowchart illustrating steps for determining ingress and/or egress routes through the structure using the structural information and situational awareness information associated with the structure, in accordance with an exemplary embodiment of the present invention. For example, the egress routes through the structure can include evacuation routes from the structure and the like. In step 2405, a list of substantially all individual paths through the structure can be maintained. In step 2410, a path weight can be assigned to each of the individual paths through the structure in accordance with, for example, the length of the individual path, the level of difficulty in traversing the individual path, and other like factors. A route between points in the structure can comprise one or more individual paths connected or otherwise joined together. In step 2415, the path weights of the individual paths that comprise the route can be summed or accumulated to generate the total path weight of the route. In step 2420, the shortest route(s) between points in, around or through the structure can be determined in accordance with the route(s) having the lowest total path weight(s). In step 2425, path weights can be modified to alter the route between the points in the structure. In step 2430, distance measurements can be calculated for each of the ingress and egress routes through the structure for display to the user. In step 2435, the ingress and/or egress routes, as well as the associated route information (e.g., distance calculations), can be rendered in the 3-D virtual model for display to the user.

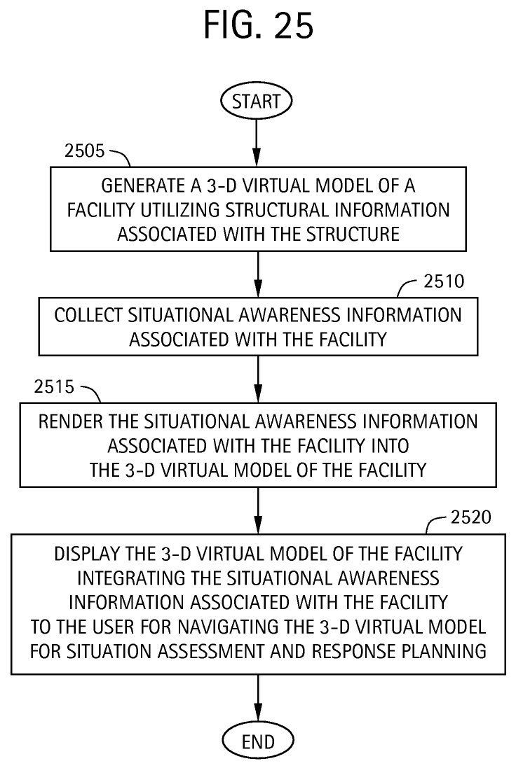

FIG. 25 is a flowchart illustrating steps for responding to an emergency, in accordance with an alternative exemplary embodiment of the present invention. In step 2505, a 3-D virtual model of a facility can be generated utilizing structural information associated with the facility. In step 2510, situational awareness information associated with the facility can be gathered or otherwise collected. In step 2515, the situational awareness information associated with the facility can be rendered into the 3-D virtual model of the facility. In step 2520, the 3-D virtual model of the facility integrating the situational awareness information associated with the facility can be displayed to a user for navigating the 3-D virtual model for situation assessment and emergency response planning.

Each, all or any combination of the steps of a computer program as illustrated in FIGS. 23-25 for providing situational awareness for a structure and for responding to an emergency can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Exemplary embodiments of the present invention can be used in conjunction with any device, system or process for providing crisis management, security and surveillance, situational awareness, incident management, intelligence analysis support, tactical operations support, forensic content management or the like. Exemplary embodiments of the present invention can provide users with end-user cost-savings and increased operational efficiencies. For example, the system can provide savings or offset for emergency management agencies from deploying and/or allocating resources more efficiently and effectively. With specific building knowledge and real-time or near real-time data streams, significant cost savings can be achieved by simply reducing the number of false alarms that are responded to and tie up valuable resources. Additionally, offsets from casualty insurance discounts can be gained by minimizing damage to life, limb and property from fire, flood, accidents, earthquake, and acts of violence or terrorism by providing critical information to first responders. Furthermore, offsets in the form of labor savings can be achieved in the on-going facilities management process. Exemplary embodiments can assist in improving operational efficiencies from the remote command and control of critical systems.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and applications, foreign patents and applications, and publications discussed above are hereby incorporated by reference herein in their entireties.

What is claimed is:

1. A system for providing situational awareness for a structure, comprising:
a database module,
wherein the database module is configured to store structural information associated with the structure;
a situational awareness module,
wherein the situational awareness module is configured to gather situational awareness information associated with the structure;
a three-dimensional (3-D) rendering module in communication with the database module and the situational awareness module,
wherein the 3-D rendering module is configured to render a 3-D virtual model of the structure utilizing the structural information associated with the structure, and
wherein the 3-D rendering module is configured to integrate into the 3-D virtual model the situational awareness information associated with the structure; and
a graphical user interface (GUI) module in communication with the 3-D rendering module,
wherein the GUI module is configured to display to a user the 3-D virtual model of the structure integrating the situational awareness information associated with the structure.

2. The system of claim 1, comprising:
a path selection module in communication with the 3-D rendering module,
wherein the path selection module is configured to determine at least one of ingress and egress routes through the structure using the structural information and situational awareness information associated with the structure, and
wherein the 3-D rendering module is configured to render in the 3-D virtual model the at least one of ingress and egress routes for display to the user.

3. The system of claim 2, wherein the path selection module is configured to determine a shortest route between points within the structure, and
wherein the 3-D rendering module is configured to render in the 3-D virtual model the shortest route for display to the user.

4. The system of claim 2, wherein the path selection module is configured to maintain a list of substantially all individual paths through the structure,
wherein each of the individual paths through the structure is assigned a path weight in accordance with at least one of a length of the individual path and a level of difficulty in traversing the individual path,
wherein a route between points in the structure comprises at least one individual path,
wherein the path selection module is configured to generate a total path weight of the route by summing the path weights of the individual paths that comprise the route, and
wherein the 3-D rendering module is configured to render in the 3-D virtual model the route between the points in the structure with a lowest total path weight for display to the user.

5. The system of claim 1, comprising:
a communication module in communication with the situational awareness module,
wherein the communication module is configured to transmit and receive the situational awareness information.

6. The system of claim 5, wherein the communication module is configured to transmit and receive the situational awareness information for collaborative situation assessment and response planning.

7. The system of claim 1, comprising:
a model translation module in communication with the 3-D rendering module and the GUI module,
wherein the model translation module is configured to convert the 3-D virtual model rendered by the 3-D rendering module into a format displayable by the GUI module.

8. The system of claim 1, comprising:
a simulation module in communication with the 3-D rendering module,
wherein the simulation module is configured to generate simulations of situational awareness scenarios associated with the structure.

9. The system of claim 1, comprising:
a situational awareness response module in communication with the 3-D rendering module,
wherein the situational awareness response module is configured to generate at least one proposed response to an emergency situation occurring within the structure.

10. The system of claim 1, wherein the structural information used by the 3-D rendering module to render the 3-D virtual model includes attributes of objects associated with the structure.

11. The system of claim 10, wherein the GUI module is configured to display the attributes of each object to the user upon request.

12. The system of claim 10, wherein the 3-D virtual model comprises a parametric 3-D virtual model, and
wherein a modification to at least one attribute of a first object is configured to cause the 3-D rendering module to modify attributes of at least a second object associated with the first object within the parametric 3-D virtual model.

13. The system of claim 10, wherein the objects comprise smart objects, and
wherein the 3-D rendering module is configured to render an impact of an action directed to a smart object in accordance with the attributes of the smart object and a nature of the action for display to the user.

14. The system of claim 1, wherein the situational awareness information includes sensor data received from sensors associated with the structure.

15. The system of claim 14, wherein the sensor data comprises historical sensor data and substantially real-time sensor data.

16. The system of claim 14, wherein the 3-D rendering module is configured to render in the 3-D virtual model the sensor data for display to the user.

17. The system of claim 16, wherein at least one sensor is displayed within the 3-D virtual model as a linking point, and
wherein a user selection of a linking point is configured to display to the user the sensor data received from the corresponding sensor.

18. The system of claim 1, wherein the situational awareness information includes substantially real-time information associated with an emergency occurring within the structure.

19. An emergency response system, comprising:
a situational awareness engine,
wherein the situational awareness engine is configured to gather substantially real-time situational awareness information associated with a facility;
a three-dimensional (3-D) model generation engine in communication with the situational awareness engine,
wherein the 3-D virtual model generation engine is configured to generate a 3-D virtual model of the facility utilizing structural information associated with the facility, and
wherein the 3-D virtual model generation engine is configured to incorporate into the 3-D virtual model the situational awareness information associated with the facility; and
a display engine in communication with the 3-D virtual model generation engine,
wherein the display engine is configured to display the 3-D virtual model of the facility incorporate the situational awareness information associated with the facility to a user for navigating the 3-D virtual model for situation assessment and emergency response planning.

20. The system of claim 19, wherein the situational awareness engine comprises:
a transceiver,
wherein the transceiver is configured to transmit and receive the situational awareness information.

21. The system of claim 19, comprising:
a situational awareness response engine in communication with the 3-D virtual model generation engine,
wherein the situational awareness response engine is configured to generate at least one proposed response to an emergency situation occurring within the facility.

22. The system of claim 21, wherein the situational awareness response engine comprises:
a simulation engine,
wherein the simulation engine is configured to generate simulations of situational awareness scenarios associated with the facility.

23. The system of claim 21, wherein the situational awareness response engine comprises:
a path determination engine,
wherein the path determination engine is configured to determine at least one of ingress and egress routes through the facility using the structural information and situational awareness information associated with the facility, and
wherein the 3-D virtual model generation engine is configured to render in the 3-D virtual model the at least one of ingress and egress routes for display to the user.

24. The system of claim 19, wherein the 3-D virtual model generation engine comprises:
a model translation engine,
wherein the model translation engine is configured to convert the 3-D virtual model generated by the 3-D virtual model generation engine into a format displayable by the display engine.

25. A method of providing situational awareness for a structure, comprising the steps of:
a.) collecting structural information associated with the structure;
b.) gathering situational awareness information associated with the structure;
c.) rendering a three-dimensional (3-D) virtual model of the structure utilizing the structural information associated with the structure;
d.) integrating into the 3-D virtual model the situational awareness information associated with the structure; and
e.) displaying to a user the 3-D virtual model of the structure integrating the situational awareness information associated with the structure.

26. The method of claim 25, comprising the steps of:
f) determining at least one of ingress and egress routes through the structure using the structural information and situational awareness information associated with the structure; and
g.) rendering in the 3-D virtual model the at least one of ingress and egress routes for display to the user.

27. The method of claim 26, wherein step (f) comprises the steps of:
f1.) maintaining a list of substantially all individual paths through the structure;
f2.) assigning a path weight to each of the individual paths through the structure in accordance with at least one of a length of the individual path and a level of difficulty in traversing the individual path,
wherein a route between points in the structure comprises at least one individual path; and
f3.) summing the path weights of the individual paths that comprise the route to generate a total path weight of the route; and
wherein step (g) comprises the step of:
g1.) rendering in the 3-D virtual model the route between the points in the structure with a lowest total path weight for display to the user.

28. The method of claim 25, comprising the step of:
f.) converting the 3-D virtual model into a format displayable in step (e).

29. The method of claim 25, comprising step of:
f.) generating simulations of situational awareness scenarios associated with the structure.

30. The method of claim 25, comprising the step of:
f.) generating at least one proposed response to an emergency situation occurring within the structure.

31. A method of responding to an emergency, comprising the steps of:
a.) generating a three-dimensional (3-D) virtual model of a facility utilizing structural information associated with the facility;
b.) gathering substantially real-time situational awareness information associated with the facility;
c.) rendering into the 3-D virtual model the situational awareness information associated with the facility; and
d.) displaying the 3-D virtual model of the facility integrating the situational awareness information associated with the facility to a user for navigating the 3-D virtual model for situation assessment and emergency response planning.
